(19) United States
(12) Patent Application Publication
(10) Pub. No.: US 2017/0282192 A1
(43) Pub. Date: Oct. 5, 2017

(54) Electrostatic Filter

(71) Applicant: 3M INNOVATIVE PROPERTIES COMPANY, St. Paul, MN (US)

(72) Inventor: Tadahiro Takashina, Sagamihara-shi (JP)

(21) Appl. No.: 15/510,795

(22) PCT Filed: Sep. 29, 2015
(86) PCT No.: PCT/US15/52796

§ 371 Date: Mar. 13, 2017

(30) Foreign Application Priority Data
Sep. 30, 2014 (JP) 2014-201260

(51) Int. Cl. B03C 3/28; B03C 3/47; B03C 3/36

(52) U.S. Cl. CPC B03C 3/28; B03C 3/366; B03C 3/47

(57) ABSTRACT

An electrostatic filter according to one embodiment of the present invention is an electrostatic filter including a first layer and a second layer, the first layer being provided with a base and a plurality of firm protuberances extending from a face of the base and adjacent to the second layer, the protuberances including a stem having a root-ward side surface and a tip side surface, the second layer being provided with a base, a first angle constituted by either an angle between the root-ward side surface of the stem and the base of the first layer or an angle between the tip side surface of the stem and the base of the second layer being at least 90° and less than 180, and a second angle constituted by the other of the two angles thereof being at least 45° and less than 180°.

### BACKGROUND

Various gas filters (such as air filters) having functions such as dust removal or filtration are known in the art.

Japanese Translation of PCT Application No. 2002-535125 (Patent Document 1) describes a channel flow filtration medium that utilizes a contoured layer. Patent Document 1 describes that “A filtration medium array is formed from at least one layer of a flow channel assembly defined by a first contoured film layer and a second film layer. The contoured film layer has a first face and a second face, and a series of peaks on at least one face of the contoured film layer and at least one face define a flow channel having a high aspect ratio structure over at least part of the face”. Patent document 1 also describes that “at least some of the film layers have high aspect ratio structures such as ribs, stems, fibrils, or other protuberances extending over the surface area of at least one face of the film layer”.

Unexamined Japanese Patent Application Publication No. H3-72967 (Patent Document 2) describes an air filter. Patent Document 2 describes an “air filter in which a sheet-shaped electret material is worked into pleats, forming spaces for air to flow through along the folds of the pleats.”

### SUMMARY

When forming a filter having a layered structure, a flow path of gases may be disturbed if protuberances serving as supports between two adjacent layers are not sturdy enough; thus, it is desirable to make these protuberances suitably firm for the sake of a stable layered structure. If the protuberances are formed integrally with a film by expanding the film (via embossing or the like), pleating, or the like, recessed sections (cavities) are formed on rear sides of the protuberances; if the obtained film is incorporated into a layered structure, spacing between the upper and lower films will decrease if positions of the protuberances overlap, and will thereby increase pressure loss and reduce trapping efficiency. However, increasing the firmness of the protuberances will narrow the flow path by that amount, thus increasing pressure loss. In addition, increasing the firmness of the protuberances limits surface area, thus affecting trapping efficiency. There is therefore a demand to minimize pressure loss (i.e., improve gas flow) and improve trapping efficiency while stabilizing the layered structure of the filter.

An electrostatic filter according to one aspect of the present invention is an electrostatic filter including a first layer and a second layer, the first layer being provided with a base and a plurality of firm protuberances extending from a face of the base and adjacent to the second layer, the protuberances including stems having a root-ward side surface and a tip side surface, the second layer being provided with a base, a first angle constituted by either an angle between the root-ward side surface of the stem and the base of the first layer or an angle between the tip side surface of the stem and the base of the second layer being at least 90° and less than 180°, and a second angle constituted by the other of the two angles thereof being at least 45° and less than 180°.

In this aspect, the protuberances are firm, thereby stabilizing the layered structure of the filter and ensuring a flow path between the layers. In addition, broad corners for the gas flow path are established at the root and tip sides of the stems of the protuberances, with the result that gas flows not only near the center of the flow path formed between two adjacent protuberances, but also near the corners thereof, facilitating the flow of gas through the filter. It is thereby possible to minimize pressure loss and improve trapping efficiency while stabilizing the layered structure of the filter.

In accordance with one aspect of the present invention, it is possible to minimize pressure loss and improve trapping efficiency while stabilizing the layered structure of the filter.

### BRIEF DESCRIPTION OF THE DRAWINGS

FIG. 1 is a perspective view of a sheet (layer) used in an electrostatic filter according to one embodiment.

FIG. 2(a) and FIG. 2(b) are both side views of protuberances on a sheet.

FIG. 3 is a drawing illustrating a projection of a protuberance onto an imaginary plane.

FIG. 4 is a drawing of multiple examples of projected images of protuberances.

FIG. 5 is a drawing of multiple examples of projected images of protuberances.

FIG. 6 is a drawing illustrating the relationship between protuberance shape and trapping efficiency and pressure loss.

FIG. 7 is a drawing showing multiple examples of projected images of protuberances.

FIG. 8 is a drawing showing multiple examples of projected images of protuberances.

FIG. 9 is a drawing showing multiple examples of projected images of protuberances.

FIG. 10 is a drawing showing multiple examples of projected images of protuberances.

FIG. 11 is a drawing showing multiple examples of projected images of protuberances.

FIG. 12 is a drawing showing multiple examples of upper surfaces of protuberances.

FIG. 13 is a drawing showing an example of a layout for protuberances on a sheet.

FIG. 14 is a drawing showing an example of a layout for protuberances on a sheet.

FIG. 15 is a drawing showing an example of a layout for protuberances on a sheet.

FIG. 16 is a drawing showing an example of a layout for protuberances on a sheet.

FIG. 17 is a drawing showing an example of a layout for protuberances on a sheet.

FIG. 18 is a drawing showing an example of a layout for protuberances on a sheet.

FIG. 19 is a drawing showing an example of a sheet.

FIG. 20 is a drawing showing an example of a sheet.

FIG. 21 is a drawing showing an example of a sheet.

FIG. 22 is a drawing showing an example of a sheet.

FIG. 23 is a drawing showing an example of a sheet.

FIG. 24 is a drawing showing an example of a sheet.

FIG. 25 is a drawing showing an example of a sheet.

FIG. 26 is a drawing showing an example of a sheet.

FIG. 27 is a drawing showing an example of a sheet.

FIG. 28 is a perspective view and partially magnified view of an electrostatic filter according to an embodiment.

FIG. 29 is a perspective view and partially magnified view of an electrostatic filter according to an embodiment.

FIG. 30 is a perspective view of an electrostatic filter according to an embodiment.

FIG. 31 is a drawing showing a lamination example.

FIG. 32 is a drawing showing a lamination example.

FIG. 33 is a drawing showing a lamination example.

FIG. 34 is a drawing showing a lamination example.

FIG. 35 is a drawing showing a lamination example.

FIG. 36 is a graph showing trapping efficiency in a first embodiment.

FIG. 37 is a graph showing pressure loss in a first embodiment.

FIG. 38 is a graph showing trapping efficiency in a second embodiment.

FIG. 39 is a graph showing pressure loss in a second embodiment.

### DETAILED DESCRIPTION

Embodiments of the present invention will now be described in detail with reference to the attached drawings. In the descriptions of the drawings, identical or similar parts are labeled with the same reference number, and redundant descriptions thereof will be omitted.

The structure of an electrostatic filter according to one embodiment will now be described. As used in the present description, the term “filter” refers to a device or part for removing microparticles (microscopic solid matter or foreign matter) mixed in with a gas. There is no limitation whatsoever upon the type of gas. Examples of microparticles include dust, dirt, and pollen, but the target matter for removal by the electrostatic filter is not limited thereto, and the electrostatic filter may remove any type of microparticles within the gas. There is no limitation whatsoever upon the form in which the electrostatic filter is used; for example, the electrostatic filter may be applied to various articles such as masks, air conditioning equipment, automobiles, air purifiers, medical oxygen supply apparatus, heat and humidity exchangers, ventilators, and the like.

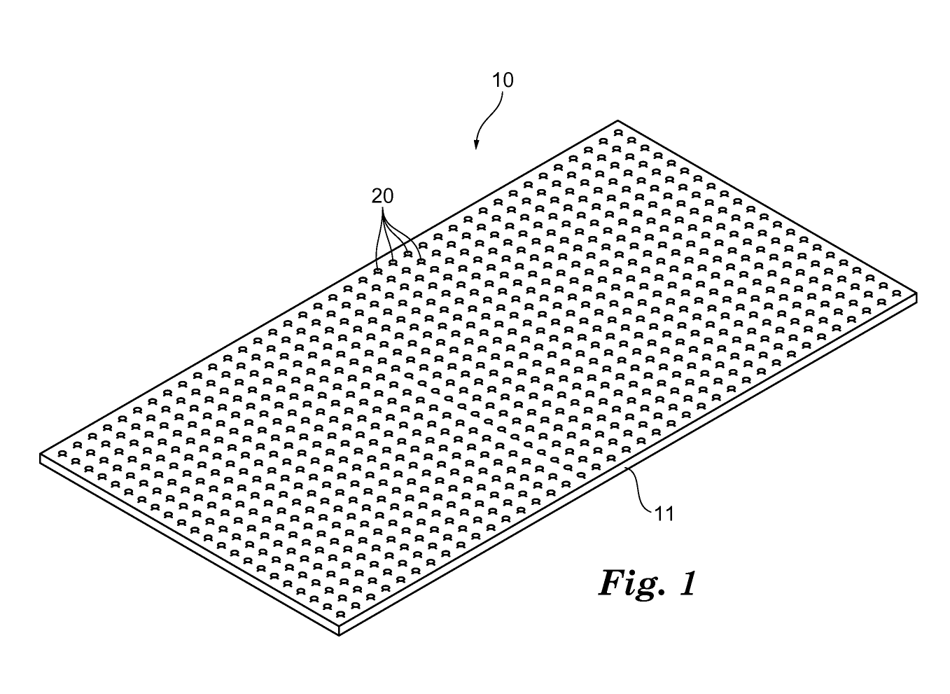

The electrostatic filter includes multiple layers. At least a part of the multiple layers are formed from a sheet 10 as shown in FIG. 1. The sheet 10 is a thin, plate-shaped member including a base 11 and a plurality of firm protuberances 20 disposed upon the base 11. As used in the present description, the term “protuberance” refers to a structural element that extends outward from one face of the base 11. In the present description, the face on which the protuberances 20 are present is defined as the front surface of the layer, sheet 10, or base 11, and the face on which the protuberances 20 are not present is defined as the rear surface of the layer, sheet 10, or base 11.

The dimensions of the sheet 10 (layer) are set according to the dimensions of the electrostatic filter. Because there is no limitation whatsoever upon the form in which the electrostatic filter is used, as discussed above, the electrostatic filter can have various dimensions, and may also be formed according to various methods, as will be discussed hereafter. Accordingly, the sheet 10 can have various lengths and widths. For example, the length and width of the sheet 10 can be anywhere from a few centimeters to several dozen meters. Meanwhile, the thickness of the sheet 10 is set while taking into account, for example, both dust removal effects (dust trapping effects) and the establishment of a gas flow path, however, there is no limitation whatsoever upon thickness. As used herein, the “thickness” of the sheet 10 is the distance from the rear surface of the base 11 to the highest points on the protuberances 20. For example, the minimum thickness of the sheet 10 may be 60 μm, 100 μm, or 140 μm, and the maximum thickness may be 2,000 μm, 900 μm, or 600 μm.

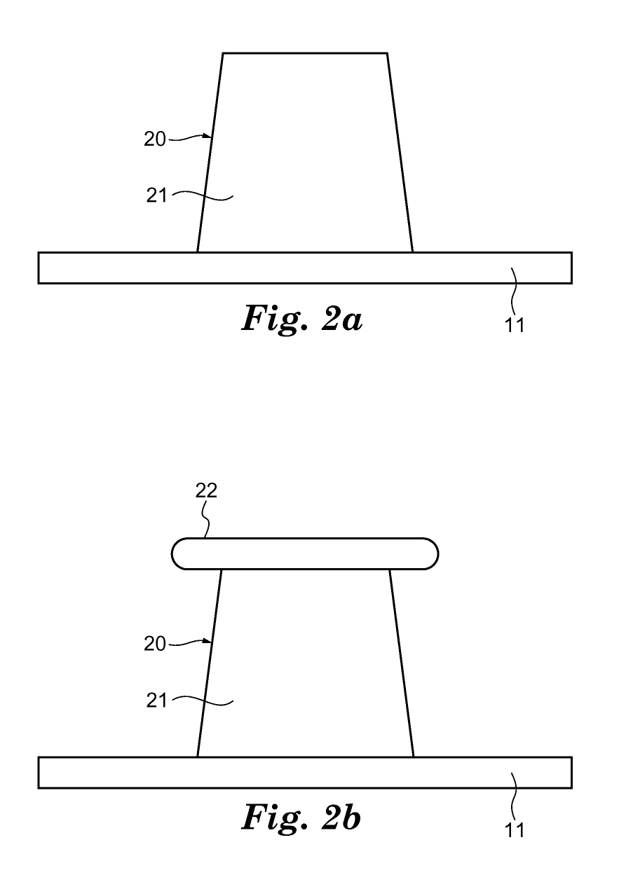

As shown in FIG. 2(a), the protuberance 20 of the present embodiment includes at least a stem 21 that extends from the front surface of the base 11. As shown in FIG. 2(b), the protuberance 20 may include a cap 22 formed at the tip of the stem 21, in which case the protuberance 20 will have an overall mushroom-like shape. However, the shape of the protuberance 20 is not limited to the examples shown in FIG. 2, and as will be discussed hereafter, various shapes are possible. The upper surface of the protuberance 20 (i.e., the upper surface of the stem 21 or the cap 22) may be flat or wavy (jagged).

There is no limitation upon the dimensions of the base 11 and the protuberance 20. For example, the thickness of the base 11, the height of the protuberance 20, the height of the stem 21, the maximum width of the base of the stem 21, the width of the tip of the stem 21, the maximum width of the cap 22, and the length to which the cap 22 protrudes out over the stem 21 may all be set as desired. There is also no limitation whatsoever upon the density of the protuberances 20 upon the base 11. For example, the density may be roughly 60 to 1,550 per cm², roughly 125 to 690 per cm², or roughly 200 to 500 per cm².

A thermoplastic resin is used as the material of the sheet 10; a thermoplastic resin suitable for extrusion can be used. Examples of thermoplastic resins include polyesters such as poly(ethylene terephthalate), polyamides such as nylon, polyolefins such as poly(styrene-acrylonitrile), poly(acrylonitrile-butadiene-styrene), and polypropylene, and plasticized polyvinyl chloride, as well as copolymers and blends thereof. Specific examples include polypropylene resin (PP), a mixture of polypropylene resin (PP) and polyethylene resin (PE), and ethylene-vinyl acetate copolymer (EVA). If a mixture of PP and PE is used, the weight ratio of PP to PE may be roughly 95:5 to 30:70. In general, greater amounts of PP will tend to increase the hardness of the protuberance 20. Conversely, lower amounts of PP will yield a softer protuberance 20. The PP may be a homopolymer or a copolymer. Examples of PE include low density polyethylene (LDPE), high density polyethylene (HDPE), and linear low density polyethylene (LLDPE).

In the present embodiment, two examples of methods of manufacturing the sheet 10 will be presented.

One method is that disclosed in the Japanese Translation of PCT Application No. 2005-514976. In this method, thermoplastic resin is extruded from a die having an opening cut via electron discharge machining, thereby forming a strip in which a plurality of rail-shaped ribs having a protuberance-shaped cross section are formed in rows on a base sheet. Next, the strip is drawn by rollers within a cooling tank filled with a liquid coolant such as water. Widthwise-directional cuts are then formed in the ribs at a plurality of discrete positions along the lengthwise direction of the rib, thereby forming a plurality of sections corresponding to the thickness of the protuberances in each of the ribs. After the ribs have been cut, the base sheet of the strip is drawn to a predetermined ratio. Specifically, the base sheet is drawn in the lengthwise direction of the ribs between first and second pairs of nip rollers being operated at difference surface speeds. In this process, the base sheet may be heated by heating one of the first pair of nip rollers disposed upstream while cooling one of the second pair of nip rollers disposed downstream in order to stabilize the base sheet. This drawing forms spaces between the plurality of sections of the ribs, and as a result, those sections form protuberances 20.

Another example is the method disclosed in the Japanese Translation of PCT Application No. 2008-532699. In this method, extrusion molding is performed using a die or extruder having a multiplicity of through-holes in order to form a strip-shaped substrate including rows of a plurality of columns having the base shape of a plurality of protuberances on the surface thereof. Next, the tips of the columns are calendered while being heated in order to allow for the formation of protuberances having cap parts. This process yields a single sheet 10.

The sheet 10 is subjected to an electret treatment. The electret-treated layer serves as an electrostatically charged layer, yielding an electrostatic filter. The electret treatment consists of electrostatically charging the sheet 10 via corona discharge, heating and cooling, and charged particle spraying, or the like. Electrostatically charging the sheet 10 allows the dust-removing or filtration effects of the layers to be enhanced.

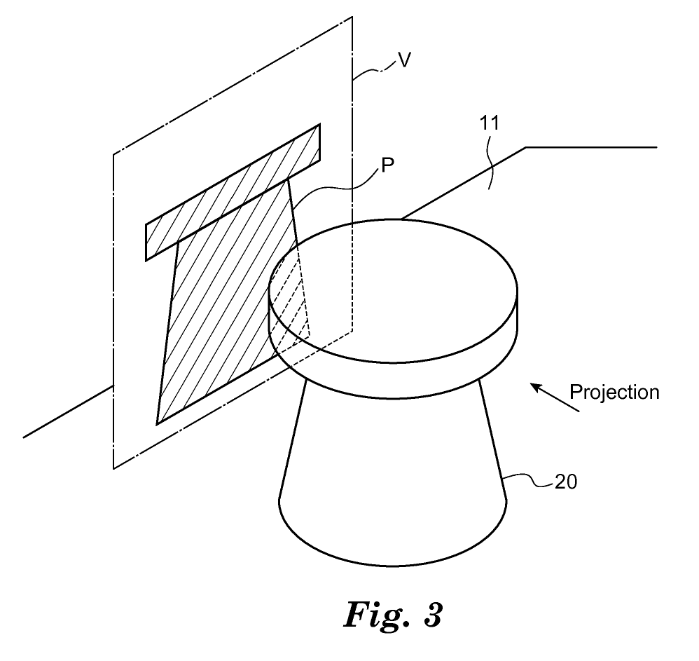

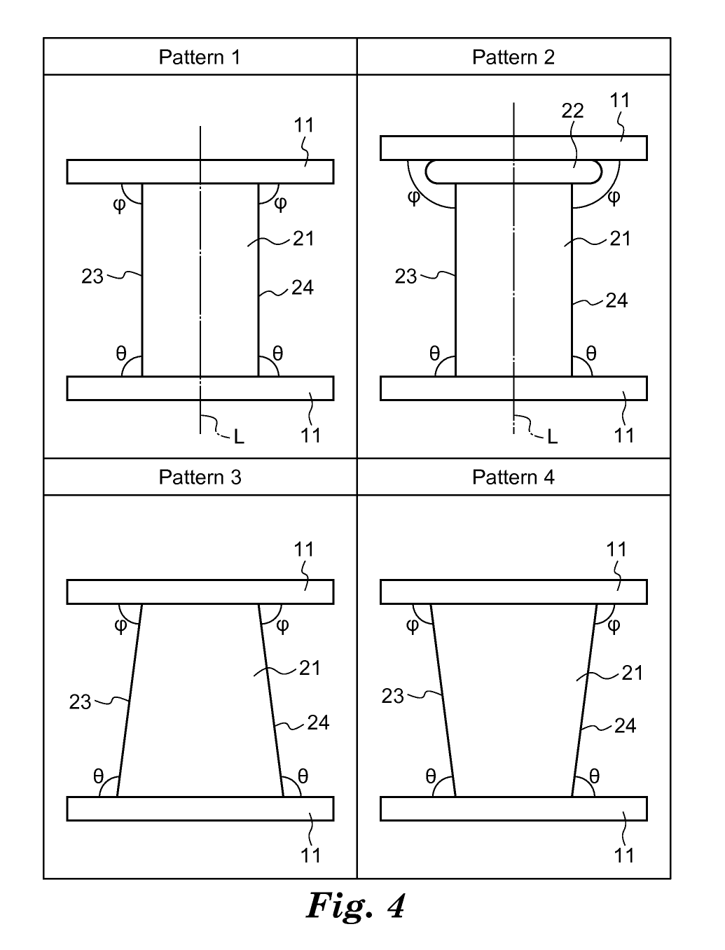

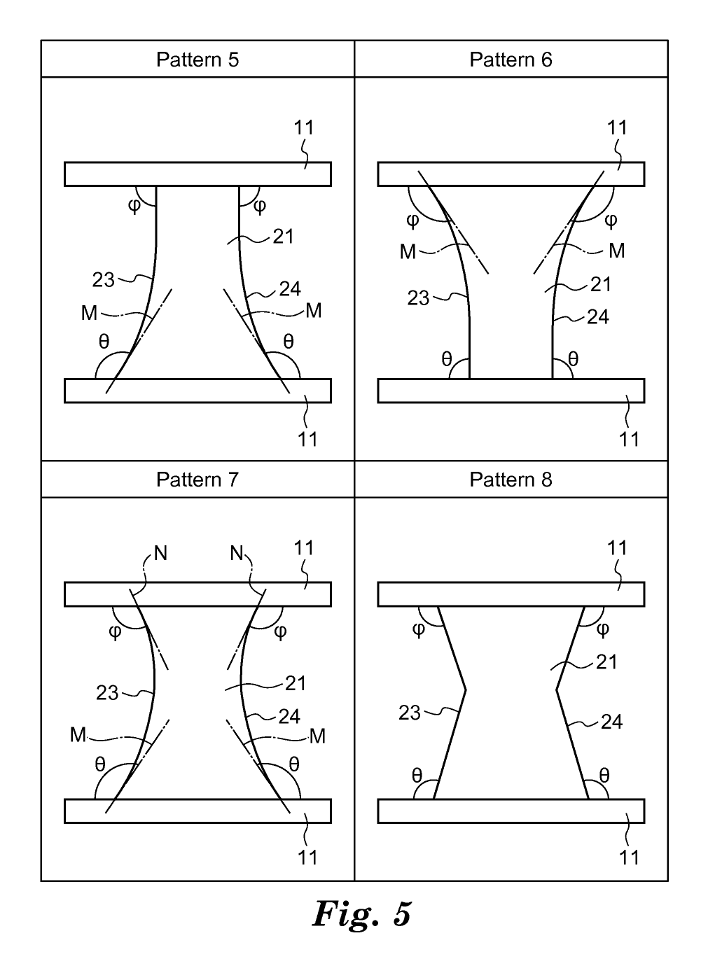

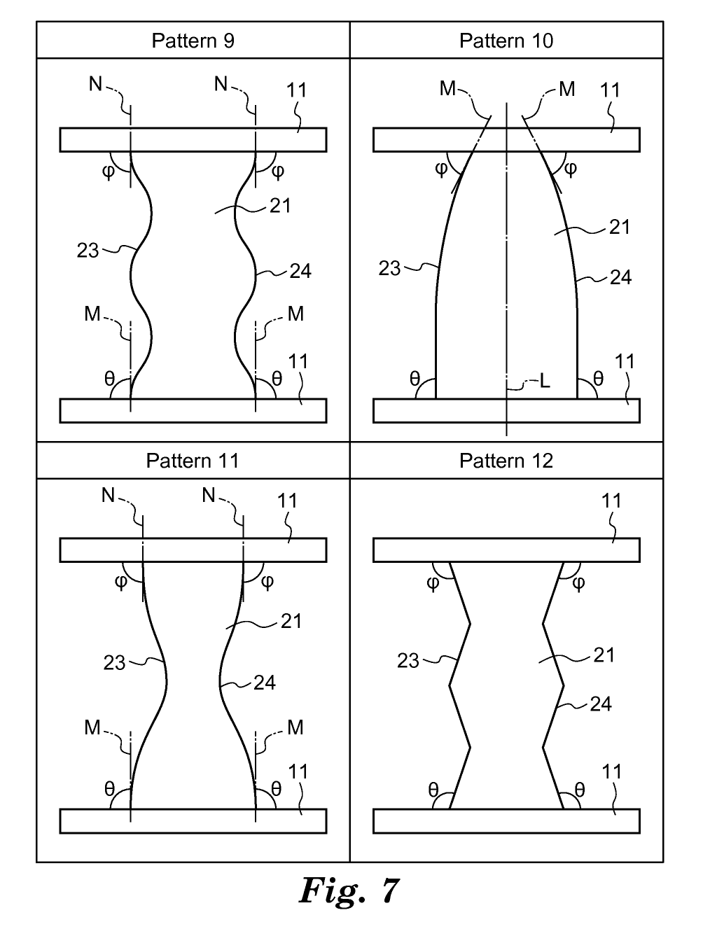

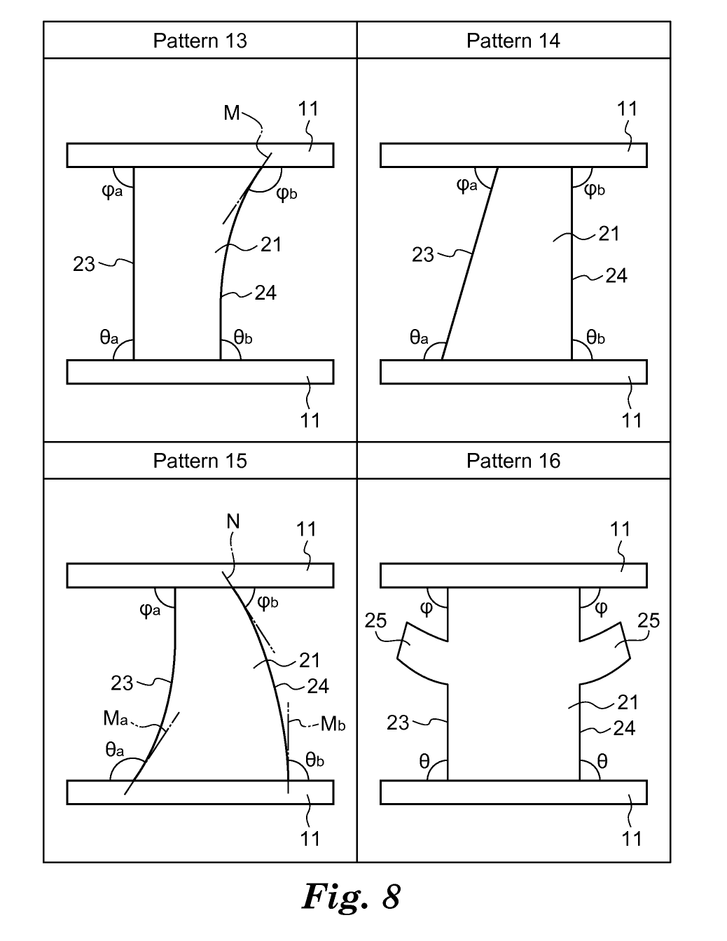

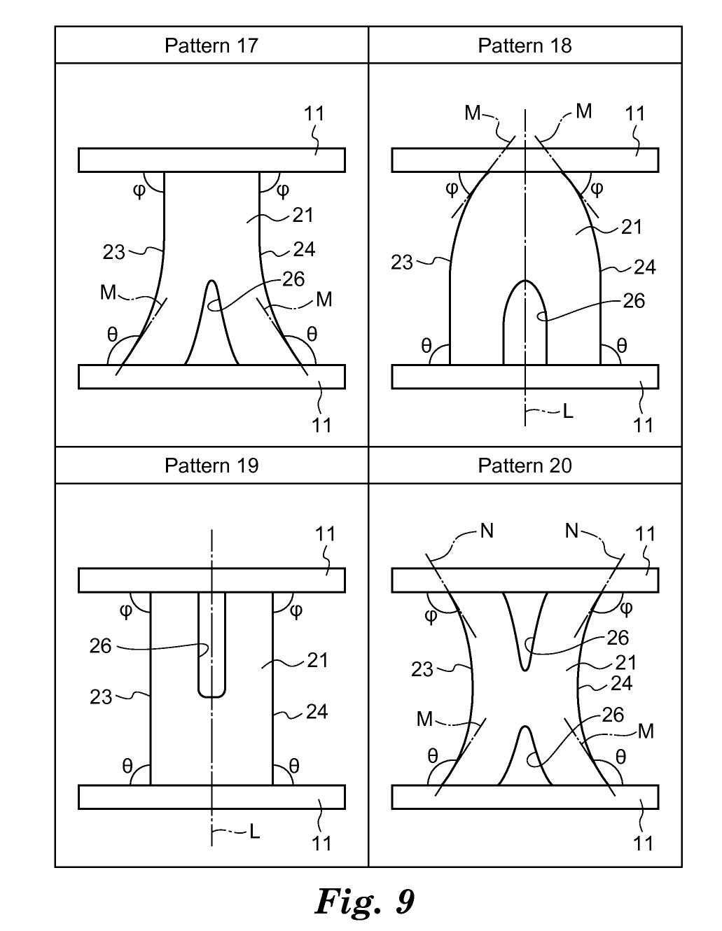

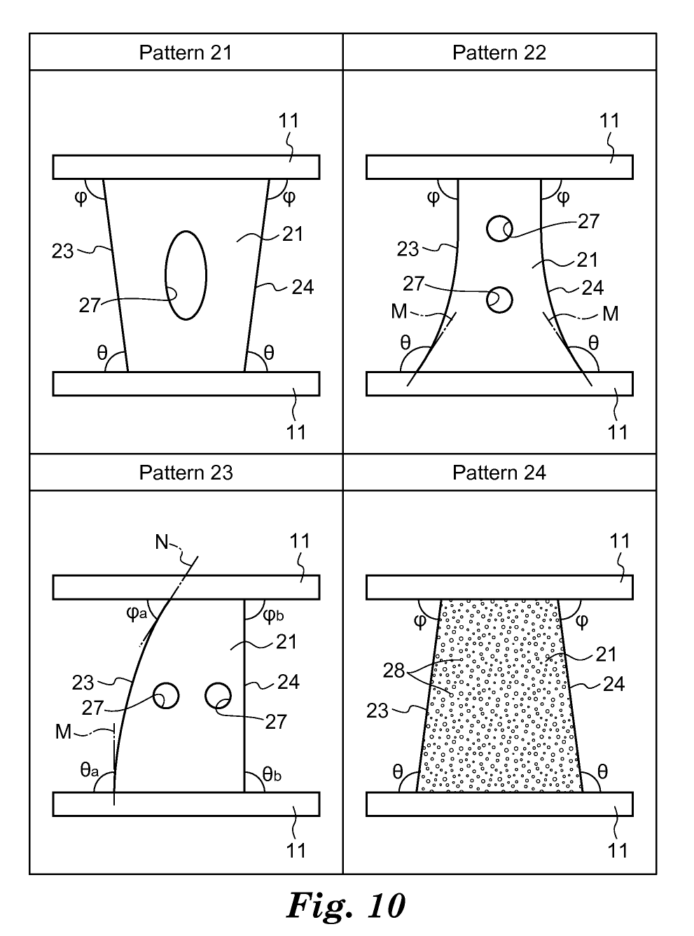

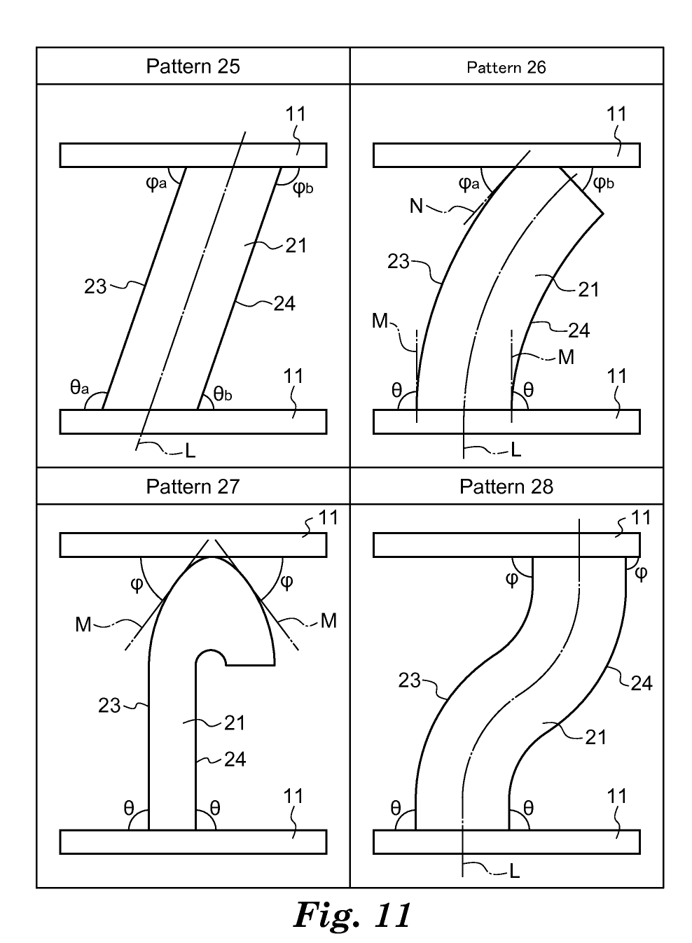

Various shapes for the protuberance 20 will now be described. The shape characteristics of the protuberances 20 can be ascertained by viewing the protuberance 20 from the side. In the present embodiment, as shown in FIG. 3, the shape characteristics of the protuberance 20 are illustrated using the outline of a projected image P obtained by projecting the protuberance 20 onto an imaginary plane V that is orthogonal to the base 11. The imaginary plane V is set so as to intersect with the gas stream direction; in other words, the imaginary plane V is set in a manner so as to cut across the gas stream. FIGS. 4 to 11 show projected images for various protuberances 20; in these drawings, the same labels appended to the protuberances are appended to the projected images to facilitate understanding of the description. In the projected images shown in FIGS. 4, 5, and 7 to 11, the first outer edge 23 and the second outer edge 24 both correspond to the side surfaces of the stem 21. In the present embodiment, that part of the side surface of the stem 21 including the section where the stems connect to the base 11 is referred to as the “root-ward side surface”, and the part including the tip of the stem 21 is referred to as the “tip side surface”. In some patterns, a reference line L indicates the direction in which the stem 21 extends. The reference line L is a line connecting the midway point between the first outer edge 23 and the second outer edge 24. In the patterns shown in FIGS. 4 to 11, the lower base 11 is equivalent to the base of the first layer, the stem 21 (protuberance 20) corresponds to the protuberances on the first layer, and the upper base 11 (i.e., the base 11 of the adjacent layer) is equivalent to the base of the second layer.

In pattern 1, the protuberance 20 does not have the cap 22, and consists only of the stem 21. The stem 21 is right cylindrical in shape. The first outer edge 23 and the second outer edge 24 are straight lines free of bends or curves. The first outer edge 23 and the second outer edge 24 can be considered to extend along the reference line L. The base 11 and the root-ward side surface of the stem 21 form an angle θ of 90°, and the tip side surface of the stem 21 and the base 11 of the adjacent layer also form an angle φ of 90°. It should be noted that the angles θ, φ referred to in the present description correspond to the shape of the gas flow path (space), not to that of the actual firm stem 21. The various “flow paths” referred to in the present description are spaces formed between two adjacent protuberances 20. The angles θ, φ are measured in the projected images of the protuberances 20. Setting right angles for angles θ, φ allows gas to flow near the corners, thereby facilitating the flow of gas through the flow path, and, by extension, minimizing the pressure loss of the electrostatic filter. In addition, the passage of gas near the corners of the flow path allows microscopic particles in the gas to be captured in the corners of the flow path and the vicinities thereof. In this way, the angles θ, φ are vital elements affecting ease of gas flow and the pressure loss value, and can also affect trapping efficiency (filtering efficiency).

Pattern 2 shows a protuberance 20 provided with a cap 22 on the end of the stem 21 shown in pattern 1. In the present description, the angle φ indicating the shape of the corners of the flow path is the angle between the tip side surface of the stem 21 and the base 11 of the adjacent layer regardless of whether a cap 22 is present or not; thus, this angle is 90° in pattern 2 as well. Thus, the presence of caps 22 does not affect the determination of angle φ. The descriptions of the patterns described hereafter are based on arrangements in which the protuberances 20 do not include caps 22.

In pattern 3, the stem 21 has a tapered shape that grows narrower approaching the tip. The first outer edge 23 and the second outer edge 24 are straight lines free of bends or curves. The angle θ formed by the base 11 and the root-ward side surface of the stem 21 is an obtuse angle. Meanwhile, the angle φ formed by the tip side surface of the stem 21 and the base 11 of the adjacent layer is an acute angle that is at least 45°. Setting an obtuse angle for angle θ further facilitates the flow of gas near the corners corresponding to angle θ. Although angle φ is an acute angle, at least a certain amount of gas will flow near the corners corresponding to angle φ as long as the angle is at least 45°. Therefore, as in patterns 1 and 2, the overall flow of gas through the flow path is facilitated, thus allowing for minimized pressure loss in the electrostatic filter. In addition, the passage of gas near the corners of the flow path allows microscopic particles in the gas to be captured in the corners of the flow path and the vicinities thereof.

In pattern 4, the stem 21 has a tapered shape that grows narrower approaching the base. The first outer edge 23 and the second outer edge 24 are straight lines free of bends or curves. The angle θ formed by the base 11 and the root-ward side surface of the stem 21 is an acute angle that is at least 45°. Meanwhile, the angle φ formed by the tip side surface of the stem 21 and the base 11 of the adjacent layer is an obtuse angle. Setting an obtuse angle for angle φ further facilitates the flow of gas near the corners corresponding to angle φ. Although angle θ is an acute angle, at least a certain amount of gas will flow near the corners corresponding to angle θ as long as the angle is at least 45°. Turning to the shape of the flow path, because pattern 4 is essentially identical to pattern 3, pressure loss can be minimized and trapping efficiency can be improved, as in pattern 3.

In pattern 5, the stem 21 has a tapered shape that grows narrower approaching the tip. Both the first outer edge 23 and the second outer edge 24 are curved along the entire lengths thereof so as to be convex with respect to the interior of the projected image. The angle θ formed by the base 11 and the root-ward side surface of the stem 21 (i.e., the angle formed by the base 11 and a supplementary line M) is an obtuse angle. Meanwhile, the angle φ formed by the tip side surface of the stem 21 and the base 11 of the adjacent layer is 90°. Setting an obtuse angle for angle θ further facilitates the flow of gas near the corners corresponding to angle θ. Setting a right angle for angle φ facilitates the flow of gas near the corners corresponding to angle φ. Setting the angles of the corners of the flow path to at least 90° and setting some of the angles to an obtuse angle in this way allows the pressure loss of the electrostatic filter to be further minimized, and also allows for the trapping of more microscopic particles from within the gas.

In pattern 6, the stem 21 has a tapered shape that grows narrower approaching the base. Both the first outer edge 23 and the second outer edge 24 are curved along the entire lengths thereof so as to be convex with respect to the interior of the projected image. The base 11 and the root-ward side surface of the stem 21 form an angle θ of 90°. Meanwhile, the angle φ formed by the tip side surface of the stem 21 and the base 11 of the adjacent layer (i.e., the angle formed by the adjacent base 11 and the supplementary line M) is an obtuse angle. Setting an obtuse angle for angle φ further facilitates the flow of gas near the corners corresponding to angle φ. Setting a right angle for angle θ facilitates the flow of gas near the corners corresponding to angle θ. Turning to the shape of the flow path, because pattern 6 is essentially identical to pattern 5, pressure loss can be minimized and trapping efficiency can be improved, as in pattern 5.

In pattern 7, the stem 21 has a shape in which the center of the length thereof is pinched inward. Both the first outer edge 23 and the second outer edge 24 are curved along the entire lengths thereof so as to be convex with respect to the interior of the projected image. The angle θ formed by the base 11 and the root-ward side surface of the stem 21 (i.e., the angle formed by the base 11 and a supplementary line M) is an obtuse angle. Meanwhile, the angle φ formed by the tip side surface of the stem 21 and the base 11 of the adjacent layer (i.e., the angle formed by the adjacent base 11 and a supplementary line N) is also an obtuse angle. Setting the angles for all of the corners of the flow path to obtuse angles in this way further facilitates the flow of gas near all of the corners of the flow path, thereby allowing the pressure loss of the electrostatic filter to be further minimized, and also allowing for the trapping of more microscopic particles from within the gas.

In pattern 8, the stem 21 has a shape in which the center of the length thereof is pinched inward. The first outer edge 23 consists of straight lines along the entire length thereof, and is bent so as to be convex with respect to the interior of the projected image. The second outer edge 24 has a shape similar to that of the first outer edge 23. The angle θ formed by the base 11 and the root-ward side surface of the stem 21 is an obtuse angle. Meanwhile, the angle φ formed by the tip side surface of the stem 21 and the base 11 of the adjacent layer is an obtuse angle. The angles of all of the corners of the flow path are obtuse angles, which, as in pattern 7, facilitates the flow of gas near all of the corners of the flow path, thereby allowing the pressure loss of the electrostatic filter to be further minimized, and also allowing for the trapping of more microscopic particles from within the gas.

In all of patterns 1 to 8, a first angle constituted by either the angle formed by the base 11 and the root-ward side surface of the stem 21 or the angle formed by the tip side surface of the stem 21 and the base 11 of the adjacent layer is at least 90° and less than 180°, and a second angle constituted by the other of the two angles thereof is at least 45° and less than 180°. Increasing the angles of the corners of the gas flow path in this way facilitates the flow of gas near the corners of the flow path, minimizing the pressure loss of the electrostatic filter. Concurrently, microscopic particles in the gas are also trapped in or near the corners of the flow path, thereby also improving trapping efficiency.

Gas flows more smoothly when the angles of the corners of the flow path are right angles than when they are acute angles, and even more smoothly when the angles are obtuse angles than when they are right angles. If the angles of all the corners of the flow path are right angles (see patterns 1 and 2), gas also flows near the corners, thereby facilitating the flow of gas through the flow path. If the angles of some of the corners of the flow path are acute angles of at least 45° and the angles of the rest of the corners are obtuse angles (see patterns 3 and 4), there is a satisfactory flow of gas throughout the flow path as a whole, thereby allowing pressure loss to be minimized to the same degree as or to a greater degree than when the angles of all of the corners of the flow path are right angles. If some of the corners of the flow path have right angles and the angles of the rest of the corners are obtuse angles (see patterns 5 and 6), pressure loss can be further minimized over cases in which the angles of all of the corners of the flow path are right angles. If all of the corners of the flow path have obtuse angles (see patterns 7 and 8), there is a satisfactory flow of gas throughout all parts of the flow path, thereby allowing pressure loss to be further minimized.

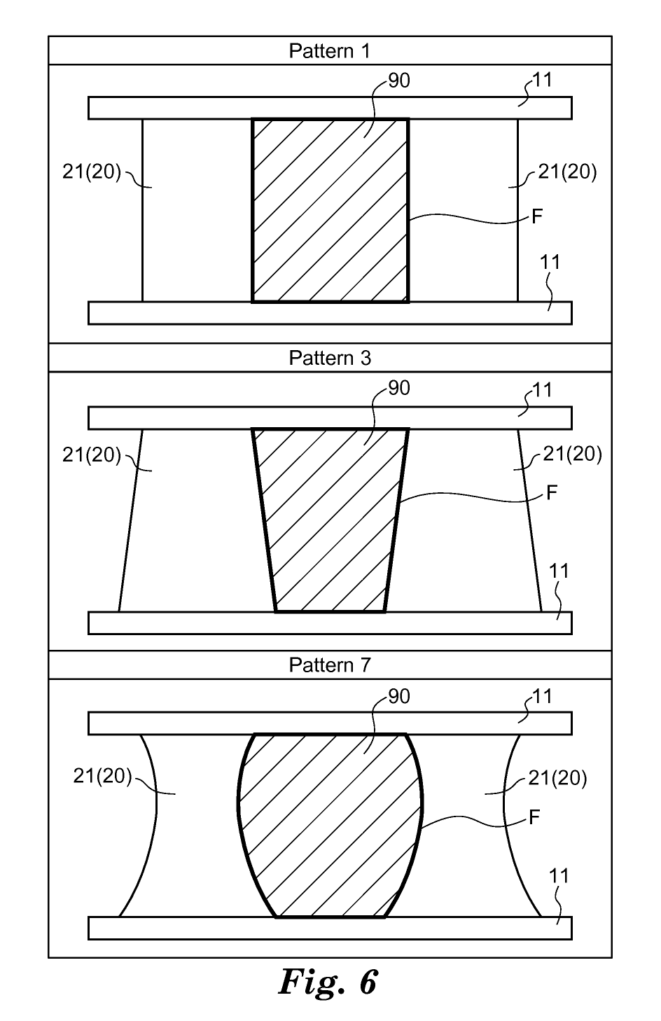

Patterns 1, 3, and 7 will now be further compared with reference to FIG. 6. FIG. 6 illustrates the cross-sectional shapes of the gas flow path 90 formed between two adjacent protuberances 20 in these three patterns. The area of the cross-sectional shape of the flow path 90 is the same in all three patterns. The length of a line (frame) F delineating the cross-sectional shape is greater in pattern 3 than in pattern 1, and greater in pattern 7 than in pattern 3. The length of the line F can be considered to represent the surface area when considered in tandem with the depth of the filter; thus, the longer line F is, the less the pressure loss is. In pattern 3, the angles of some of the corners of the flow path 90 are acute angles, but line F is longer than in pattern 1; thus, the pressure loss produced by the filter surface area is less than in pattern 1. As can be seen, the degree of pressure loss between pattern 1 and pattern 3 depends upon the balance between the angles of the corners of the flow path 90 and the length of line F (i.e., surface area). In pattern 7, the angles of all of the corners of the flow path 90 are obtuse angles, and line F is longer than in patterns 1 and 3; thus, the pressure loss is less than in patterns 1 and 3.

There is no limitation whatsoever upon the shape of the stem 21 as long as a first angle constituted by either the angle formed by the base 11 and the root-ward side surface of the stem 21 or the angle formed by the tip side surface of the stem 21 and the base 11 of the adjacent layer is at least 90° and less than 180°, and a second angle constituted by the other of the two angles thereof is at least 45° and less than 180°. Various shapes for the stems 21 will be described hereafter.

In pattern 9, the stem 21 has a shape in which the center of the length thereof is pinched inward at multiple locations. Both the first outer edge 23 and the second outer edge 24 are curved at two locations so as to be convex with respect to the interior of the projected image. Forming concave sections at these two locations creates sections that are convex with respect to the exterior of the projected image in the regions between the two concave sections. Thus, in this example, only part of the first outer edge 23 and only part of the second outer edge 24 are convex with respect to the interior of the projected image. The angle 0 formed by the base 11 and the root-ward side surface of the stem 21 (i.e., the angle formed by the base 11 and a supplementary line M) is 90°. Meanwhile, the angle φ formed by the tip side surface of the stem 21 and the base 11 of the adjacent layer (i.e., the angle formed by the adjacent base 11 and a supplementary line N) is also 90°.

In pattern 10, the stem 21 is right cylindrical at the roots, and the remaining parts of the stem 21 taper inward toward the tip thereof. The root end of the first outer edge 23 and the second outer edge 24 are straight lines, and can be considered to extend along the reference line L. By contrast, the tip end of the first outer edge 23 and the second outer edge 24 curve so as to be convex with respect to the exterior of the projected image. The base 11 and the root-ward side surface of the stem 21 form an angle θ of 90°. Meanwhile, the angle φ formed by the tip side surface of the stem 21 and the base 11 of the adjacent layer (i.e., the angle formed by the adjacent base 11 and the supplementary line M) is an acute angle of at least 45°.

In pattern 11, the stem 21 has a shape in which the center of the length thereof is pinched inward. Both the first outer edge 23 and the second outer edge 24 are curved at center sections thereof so as to be convex with respect to the interior of the projected image. The angle θ formed by the base 11 and the root-ward side surface of the stem 21 (i.e., the angle formed by the base 11 and a supplementary line M) is 90°. Meanwhile, the angle φ formed by the tip side surface of the stem 21 and the base 11 of the adjacent layer (i.e., the angle formed by the adjacent base 11 and a supplementary line N) is also 90°.

In pattern 12, the stem 21 has a shape in which the center of the length thereof is pinched inward at multiple locations. Both the first outer edge 23 and the second outer edge 24 are formed from straight lines, and are bent at two locations so as to be convex with respect to the interior of the projected image. Defining concave sections at these two locations creates sections that are convex with respect to the exterior of the projected image in the regions between the two concave sections. Thus, in this example, only part of the first outer edge 23 and only part of the second outer edge 24 are convex with respect to the interior of the projected image. The angle θ formed by the base 11 and the root-ward side surface of the stem 21 is an obtuse angle. Meanwhile, the angle φ formed by the tip side surface of the stem 21 and the base 11 of the adjacent layer is an obtuse angle.

Patterns 13 to 15 are examples in which the projected images of the stems 21 are not line-symmetrical. In pattern 13, the stem 21 has a tapered shape that grows narrower approaching the base. The first outer edge 23 is a straight line free of bends or curves. Meanwhile, the second outer edge 24 is curved along the entire length thereof so as to be convex with respect to the interior of the projected image. The angle θₐ formed by the base 11 and the root side of the first outer edge 23 (the root-ward side surface of the stem 21) is 90°. The angle θₐ formed by the base 11 and the root side of the second outer edge 24 (the root-ward side surface of the stem 21) is also 90°. The angle φₐ formed by the tip side of the first outer edge 23 (the tip side surface of the stem 21) and the base 11 of the adjacent layer is 90°. The angle φ_{b} formed by the tip side of the second outer edge 24 (the tip side surface of the stem 21) and the base 11 of the adjacent layer (i.e., the angle formed by the supplementary line M and the adjacent base 11) is an obtuse angle.

In pattern 14, the stem 21 has a tapered shape that grows narrower approaching the tip. The first outer edge 23 and the second outer edge 24 are straight lines free of bends or curves. The angle θₐ formed by the base 11 and the root side of the first outer edge 23 (the root-ward side surface of the stem 21) is an obtuse angle. The angle θ_{b} formed by the base 11 and the root side of the second outer edge 24 (the root-ward side surface of the stem 21) is 90°. The angle φₐ formed by the tip side of the first outer edge 23 (the tip side surface of the stem 21) and the base 11 of the adjacent layer is an acute angle of at least 45°. The angle φₐ formed by the tip side of the second outer edge 24 (the tip side surface of the stem 21) and the base 11 of the adjacent layer is 90°.

In pattern 15, the stem 21 has a tapered shape that grows narrower approaching the tip. The first outer edge 23 is curved along the entire length thereof so as to be convex with respect to the interior of the projected image. Meanwhile, the second outer edge 24 is curved along the entire length thereof so as to be convex with respect to the exterior of the projected image. The angle θₐ formed by the base 11 and the root side of the first outer edge 23 (the root-ward side surface of the stem 21; i.e., the angle formed by the base 11 and the supplementary line Mₐ) is an obtuse angle. The angle θ_{b} formed by the base 11 and the root side of the second outer edge 24 (the root-ward side surface of the stem 21; i.e., the angle formed by the base 11 and the supplementary line M_{b}) is 90°. The angle φₐ formed by the tip side of the first outer edge 23 (the tip side surface of the stem 21) and the base 11 of the adjacent layer is 90°. The angle φ_{b} formed by the tip side of the second outer edge 24 (the tip side surface of the stem 21) and the base 11 of the adjacent layer (i.e., the angle formed by the supplementary line N and the adjacent base 11) is an acute angle of at least 45°.

As shown in pattern 16, the stem 21 may include branches 25 along the length thereof. In the example shown in the drawing, branches 25 are formed on both the first edge 23 and the second edge 23, but the numbers and positions of the branches 25 are not limited to this example. The base 11 and the root-ward side surface of the stem 21 form an angle θ of 90°, and the tip side surface of the stem 21 and the base 11 of the adjacent layer also form an angle φ of 90°.

Patterns 17 to 20 show embodiments in which the stems 21 have bifurcated shapes as seen in the projected images thereof, resulting in the presence of gap 26. The stems 21 may be bifurcated at the roots sides thereof, at the tip sides thereof, or at both sides. Gas is also capable of flowing through the gap 26, but the term “flow path” as defined above in the present description does not include the gap 26.

In pattern 17, the stem 21 has a tapered shape that grows narrower approaching the tip. Both the first outer edge 23 and the second outer edge 24 are curved along the entire lengths thereof so as to be convex with respect to the interior of the projected image. The angle θ formed by the base 11 and the root-ward side surface of the stem 21 (i.e., the angle formed by the base 11 and a supplementary line M) is an obtuse angle. The angle φ formed by the tip side surface of the stem 21 and the base 11 of the adjacent layer is 90°.

In pattern 18, the stem 21 is right cylindrical at the root thereof, and the remaining parts of the stem 21 taper inward toward the tip thereof. The root ends of the first outer edge 23 and the second outer edge 24 are straight lines, and can be considered to extend along the reference line L. By contrast, the tip ends of the first outer edge 23 and the second outer edge 24 curve so as to be convex with respect to the exterior of the projected image. The base 11 and the root-ward side surface of the stem 21 form an angle θ of 90°. Meanwhile, the angle φ formed by the tip side surface of the stem 21 and the base 11 of the adjacent layer (i.e., the angle formed by the adjacent base 11 and the supplementary line M) is an acute angle of at least 45°.

In pattern 19, the stem 21 has a right cylindrical shape. The first outer edge 23 and the second outer edge 24 are straight lines free of bends or curves. Alternatively, the first outer edge 23 and the second outer edge 24 can be considered to extend along the reference line L. The base 11 and the root-ward side surface of the stem 21 form an angle θ of 90°, and the tip side surface of the stem 21 and the base 11 of the adjacent layer also form an angle φ of 90°.

In pattern 20, the stem 21 has a shape in which the center of the length thereof is pinched inward. A gap 26 is present at both the root side and the tip side. Both the first outer edge 23 and the second outer edge 24 are curved along the entire lengths thereof so as to be convex with respect to the interior of the projected image. The angle θ formed by the base 11 and the root-ward side surface of the stem 21 (i.e., the angle formed by the base 11 and a supplementary line

M) is an obtuse angle. Meanwhile, the angle φ formed by the tip side surface of the stem 21 and the base 11 of the adjacent layer (i.e., the angle formed by the adjacent base 11 and a supplementary line N) is also an obtuse angle.

In patterns 21 to 23, at least one hole 27 is formed penetrating in a direction orthogonal to the direction of extension of the stem 21(hereafter, such holes will be referred to simply as “through-holes”). There is no limitation whatsoever upon the position and dimensions of individual through-holes 27. Gas is also capable of flowing through the through-hole 27, but the term “flow path” as defined above in the present description does not include the through-hole 27.

In pattern 21, the stem 21 has a tapered shape that grows narrower approaching the base. The first outer edge 23 and the second outer edge 24 are straight lines free of bends or curves. The angle θ formed by the base 11 and the root-ward side surface of the stem 21 is an acute angle that is at least 45°. Meanwhile, the angle φ formed by the tip side surface of the stem 21 and the base 11 of the adjacent layer is an obtuse angle.

In pattern 22, the stem 21 has a tapered shape that grows narrower approaching the tip. Both the first outer edge 23 and the second outer edge 24 are curved along the entire lengths thereof so as to be convex with respect to the interior of the projected image. The angle θ formed by the base 11 and the root-ward side surface of the stem 21 (i.e., the angle formed by the base 11 and a supplementary line M) is an obtuse angle. The angle φ formed by the tip side surface of the stem 21 and the base 11 of the adjacent layer is 90°.

In pattern 23, the stem 21 has a tapered shape that grows narrower approaching the tip and is not line symmetrical. The first outer edge 23 is curved along the entire length thereof so as to be convex with respect to the exterior of the projected image. Meanwhile, the second outer edge 24 is a straight line free of bends or curves. The angle 0. formed by the base 11 and the root side of the first outer edge 23 (the root-ward side surface of the stem 21; i.e., the angle formed by the base 11 and the supplementary line M) is 90°. The angle φₐ formed by the base 11 and the root side of the second outer edge 24 (the root-ward side surface of the stem 21) is also 90°. The angle φₐ formed by the tip side of the first outer edge 23 (the tip side surface of the stem 21) and the base 11 of the adjacent layer (i.e., the angle formed by the supplementary line N and the adjacent base 11) is an acute angle of at least 45°. The angle φₐ formed by the tip side of the second outer edge 24 (the tip side surface of the stem 21) and the base 11 of the adjacent layer is 90°.

In pattern 24, the stem 21 has a tapered shape that grows narrower approaching the tip. The first outer edge 23 and the second outer edge 24 are straight lines free of bends or curves. In this example, multiple tiny holes 28 are formed in the stem 21, thereby imparting the stem 21 with a porous texture. Gas is also capable of flowing through the holes 28, but the term “flow path” as defined above in the present description does not include the holes 28. The angle θ formed by the base 11 and the root-ward side surface of the stem 21 is an obtuse angle. Meanwhile, the angle φ formed by the tip side surface of the stem 21 and the base 11 of the adjacent layer is an acute angle that is at least 45°.

Further examples of shapes for the protuberance 20 are shown in patterns 25 to 28. In pattern 25, the stem 21 has an inclined cylindrical shape. The first outer edge 23 and the second outer edge 24 are straight lines free of bends or curves. Alternatively, the first outer edge 23 and the second outer edge 24 can be considered to extend along the reference line L, as in pattern 1. The angle θₐ formed by the base 11 and the root side of the first outer edge 23 (the root-ward side surface of the stem 21) is an obtuse angle. The angle θ_{b} formed by the base 11 and the root side of the second outer edge 24 is an acute angle of at least 45°. The angle φₐ formed by the tip side of the first outer edge 23 (the tip side surface of the stem 21) and the base 11 of the adjacent layer is an acute angle of at least 45°. The angle φ_{b} formed by the tip side of the second outer edge 24 (the tip side surface of the stem 21) and the base 11 of the adjacent layer is an obtuse angle.

In pattern 26, the stem 21 is shaped like a cylinder that curves in an arc. The first outer edge 23 and the second outer edge 24 extend along a reference line L. The angle θ formed by the base 11 and the root-ward side surface of the stem 21 (i.e., the angle formed by the base 11 and a supplementary line M) is 90°. The angle φₐ formed by the tip side of the first outer edge 23 (the tip side surface of the stem 21) and the base 11 of the adjacent layer (i.e., the angle formed by the supplementary line N and the adjacent base 11) is an acute angle of at least 45°. The angle φ_{b} formed by the outer edge corresponding to the upper surface of the stem 21 and the base 11 of the adjacent layer is an acute angle of at least 45°.

In pattern 27, the stem 21 is shaped like a cylinder that curves in a letter-J shape. The base 11 and the root-ward side surface of the stem 21 form an angle θ of 90°. At the part of the stem 21 contacting the base 11 of the adjacent layer, the angle φ formed by the side surface of the stem 21 and the base 11 of the adjacent layer (i.e., the angle formed by supplementary line M and the adjacent base 11) is an acute angle of at least 45°.

In pattern 28, the stem 21 is shaped like a cylinder that curves near the center thereof. The first outer edge 23 and the second outer edge 24 extend along a reference line L. The base 11 and the root-ward side surface of the stem 21 form an angle θ of 90°, and the tip side surface of the stem 21 and the base 11 of the adjacent layer form also an angle φ of 90°.

As can be seen, there is no limitation whatsoever upon the shapes of the protuberance 20 and the stem 21 as long as a first angle constituted by either the angle formed by the base 11 and the root-ward side surface of the stem 21 or the angle formed by the tip side surface of the stem 21 and the base 11 of the adjacent layer is at least 90° and less than 180°, and a second angle constituted by the other of the two angles thereof is at least 45° and less than 180°. The minimum angle for the first angle may be 100°, 110°, 120°, 130°, 140°, 150°, 160°, or 170°, and the maximum angle may be 100°, 110°, 120°, 130°, 140°, 150°, 160°, or 170°. The minimum angle for the second angle may be 50°, 60°, 70°, 80°, 90°, 100°, 110°, 120°, 130°, 140°, 150°, 160°, or 170°, and the maximum angle may be 50°, 60°, 70°, 80°, 90°, 100°, 110°, 120°, 130°, 140°, 150°, 160°, or 170°.

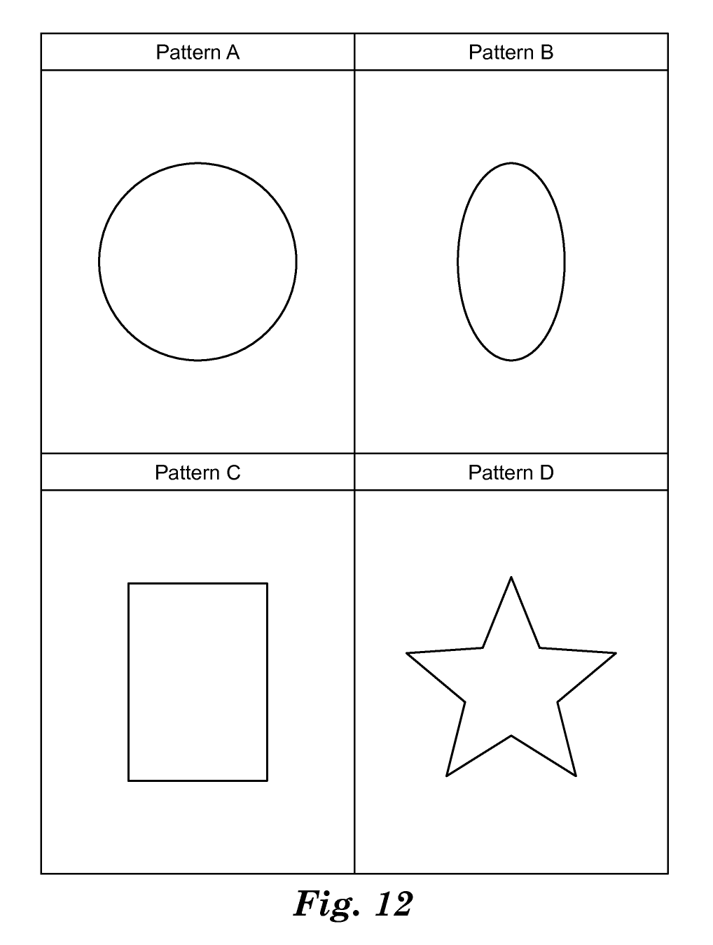

The shape of the upper surface of the protuberance 20 (i.e., the upper surface of the stem 21 or the cap 22), which is parallel to the base 11, may be set as desired. For example, as shown in FIG. 12, the upper surface may be circular in shape (pattern A), ellipsoid (pattern B), rectangular (pattern C), or star-shaped (pattern D). Alternatively, the upper surface may have any desired polygonal shape, such as triangular or hexagonal, or may have a more complex shape.

As discussed above, various shapes are possible for the protuberance 20, and the shape thereof may be determined out of consideration for the totality of circumstances such as the shape or dimensions of the material to be trapped, air resistance, trapping efficiency, the generation of turbulence within the flow path, and the stability of the layered structure of the electrostatic filter.

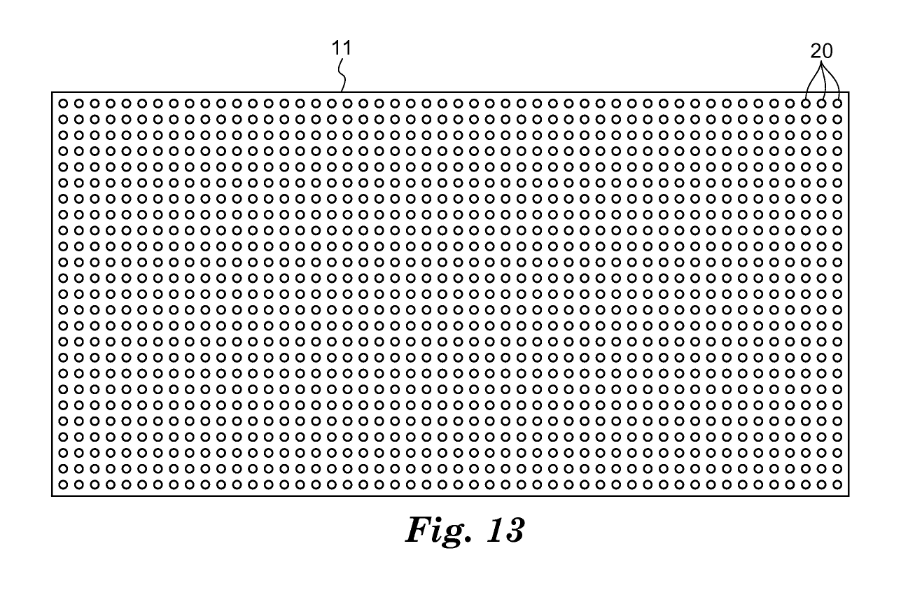

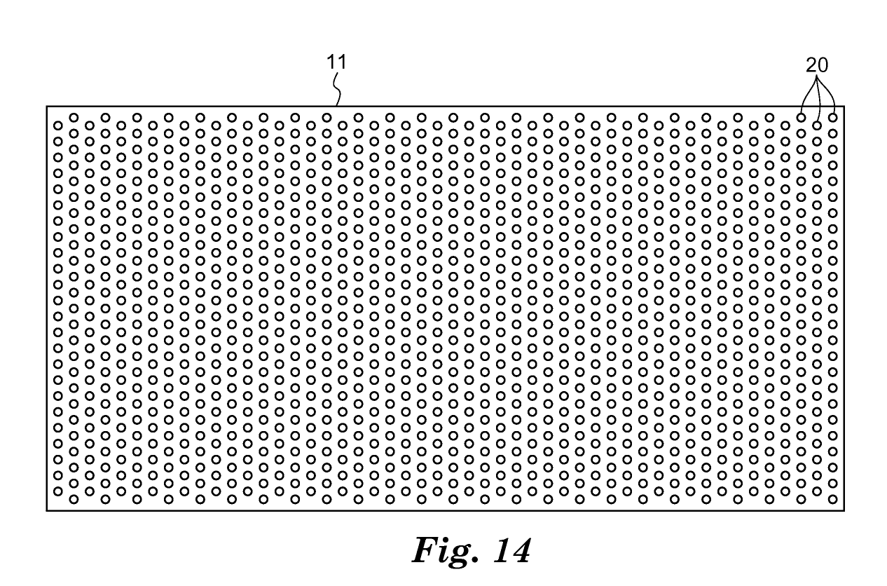

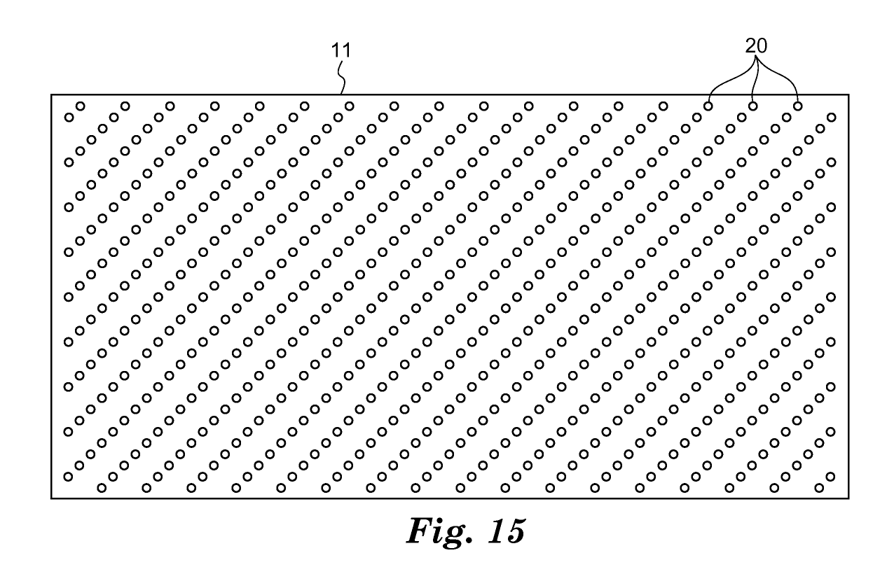

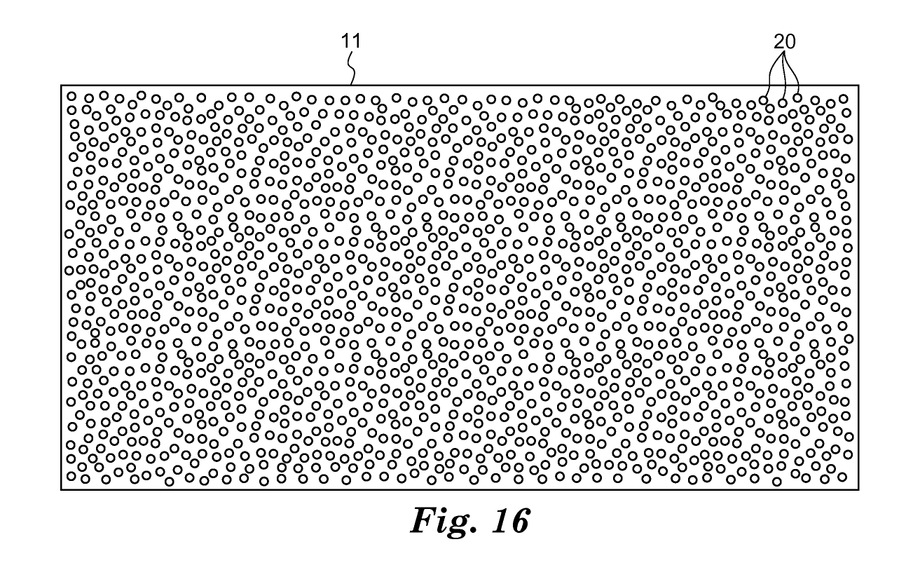

There is no limitation upon the specific layout of the plurality of protuberances 20 on the base 11. For example, the protuberances 20 may be arranged in a grid-like pattern as shown in FIG. 13, or in a staggered pattern as shown in FIG. 14. Alternatively, rows of protuberances 20 may be arranged at a slant with respect to the outer edges of the base 11 as shown in FIG. 15, or the protuberances 20 may be randomly arranged, as shown in FIG. 16. The layout of the protuberances 20 is not limited to these examples; any pattern is acceptable as long as it is capable of forming a gas flow path.

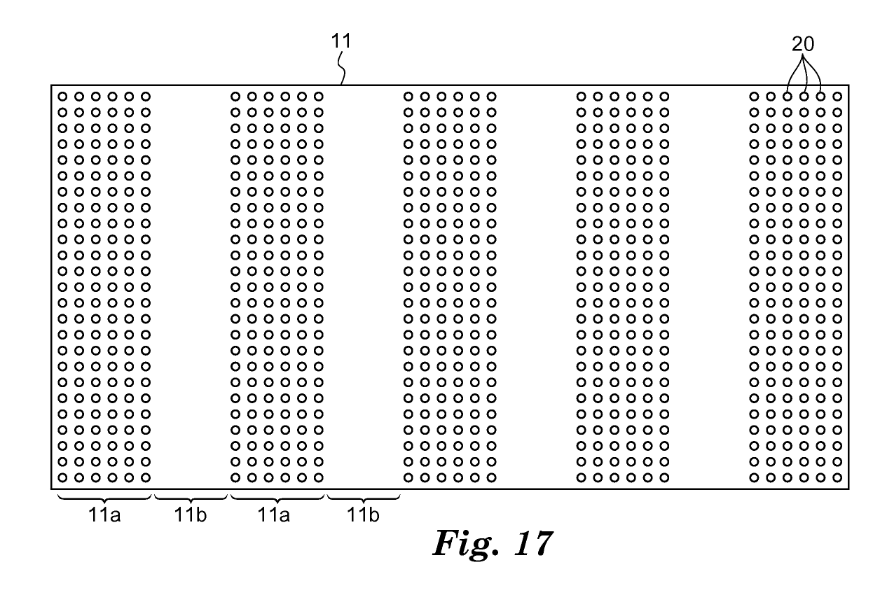

The protuberances 20 may be arranged uniformly or non-uniformly over the base 11. A number of non-uniform examples will now be described. For example, a mixture of protuberance regions 11a in which protuberances 20 are present and smooth regions 11 in which protuberances 20 are not present may be present on the base 11, as shown in FIG. 17. In FIG. 17, the protuberance regions 11a and smooth regions 11b are both rectangular, but there is no limitation whatsoever upon the shapes of these regions, and any desired shape may be selected (such as circles, ellipses, stars, a desired polygon, stripes, lattices, waves, or a combination of multiple types of these shapes). A thin, plate-shaped member that is different from the sheet 10 may be used as a substrate to which part of the sheet 10 is partially bonded, thereby forming protuberance regions 11a in which the sheet 10 is bonded and smooth regions 11b in which the sheet 10 is not bonded. Gas flows smoothly over the smooth regions 11b, thereby allowing for the further suppression of pressure loss in the electrostatic filter as a whole.

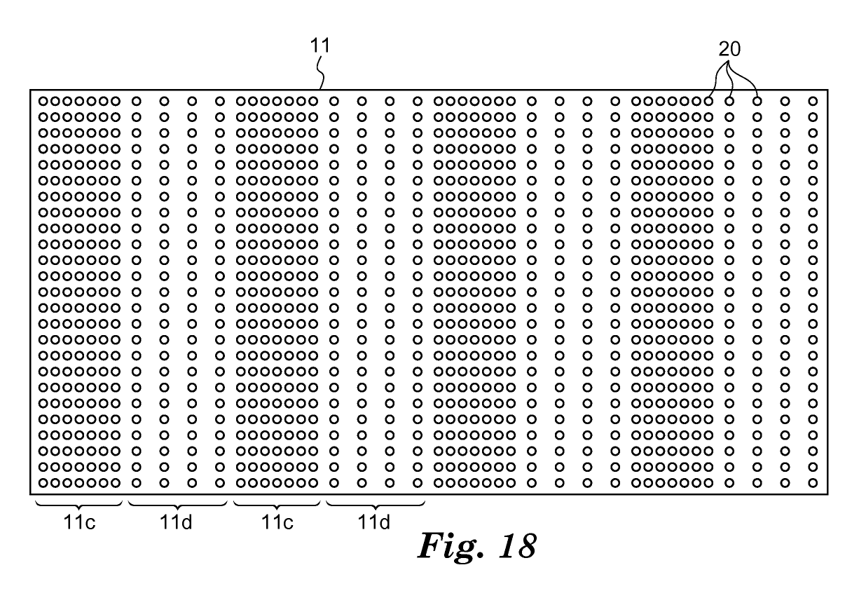

Alternatively, as shown in FIG. 18, a mixture of regions 11c containing densely arranged protuberances 20 (dense areas) and regions 11d containing scattered protuberances 20 (diffuse regions) may be present on a single sheet 10. There is no limitation upon the shapes of the dense regions 11c and the diffuse regions 11d, and any desired shape may be selected (such as circles, ellipses, stars, a desired polygon, stripes, lattices, waves, or a combination of multiple types of these shapes). Alternatively, a thin, plate-shaped member that differs from the sheet 10 can be used as a substrate, a sheet 10 including densely arranged protuberances 20 can be glued or melt-bonded to part of the substrate, and a sheet 10 including scattered protuberances 20 can be bonded to the remaining parts of the sheet 10 via a similar method to form dense regions 11c and diffuse regions 11d. Gas flows more smoothly over the diffuse regions 11d than the dense regions 11c, thereby allowing for the further suppression of pressure loss in the electrostatic filter as a whole.

Multiple types of protuberances may be provided on a single base 11. For example, protuberances of different dimensions, protuberances of different shapes (patterns), or protuberances of both different shapes and different dimensions may be provided on a single base.

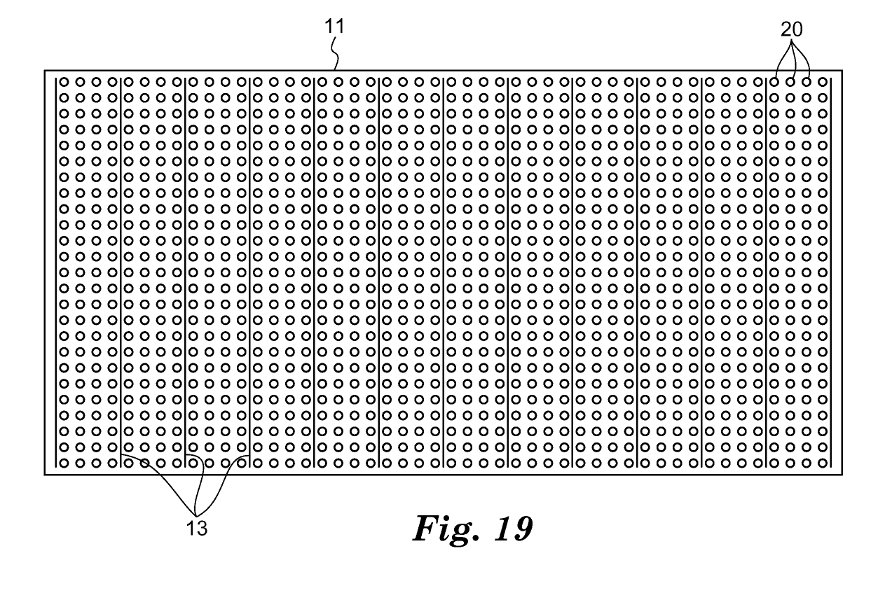

A slit or opening may be formed in the base 11. These slits and openings will be described using FIGS. 19 to 27. As used in the present description, the term “slit” is a concept including slit-shaped grooves and slit-shaped through-holes. As used in the present description, the term “groove” refers to a cut-out section formed in one side of the base 11 that does not penetrate through to the other side. These grooves may be formed on the front surface or the rear surface of the base 11. As used in the present description, the term “through-hole” refers to a hole or opening provided in the base 11 that penetrates from one side through to the other. In the present description, both slit-shaped grooves and slit-shaped through-holes will be collectively referred to simply as “slits”. In the present embodiment, a linear slit is used, but the slit may have any shape, such as wavy, zig-zagging, or undulating.

The slit can be formed according to any conventionally used method (such as via blade or laser cutting). Meanwhile, the opening can be formed, for example, by expanding a base 11 in which slit-shaped through-holes have been formed in a direction orthogonal to the direction of a row of slits. Examples of means of expanding the base 11 include devices such as tenters or rollers, or by hand. Alternatively, an opening 14 may be formed by boring an opening of the desired shape in the base 11 without expanding the base 11.

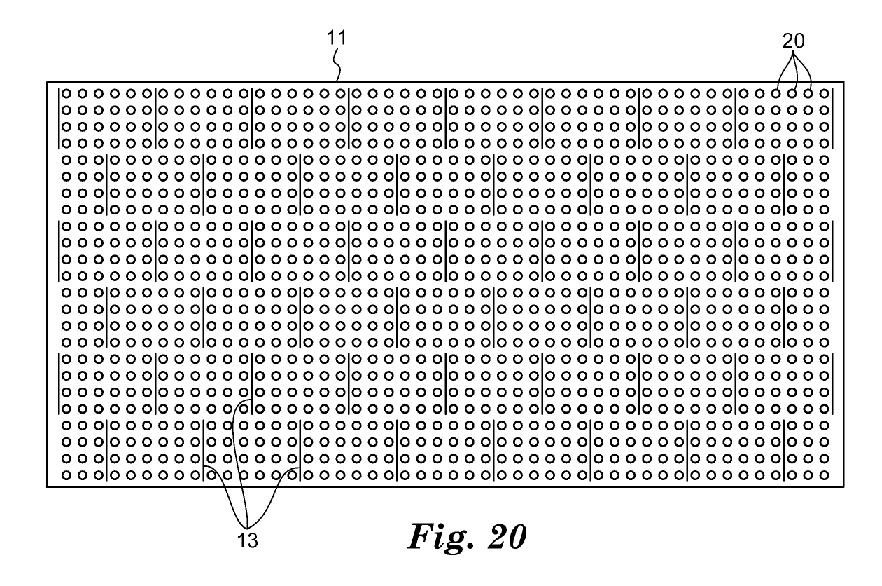

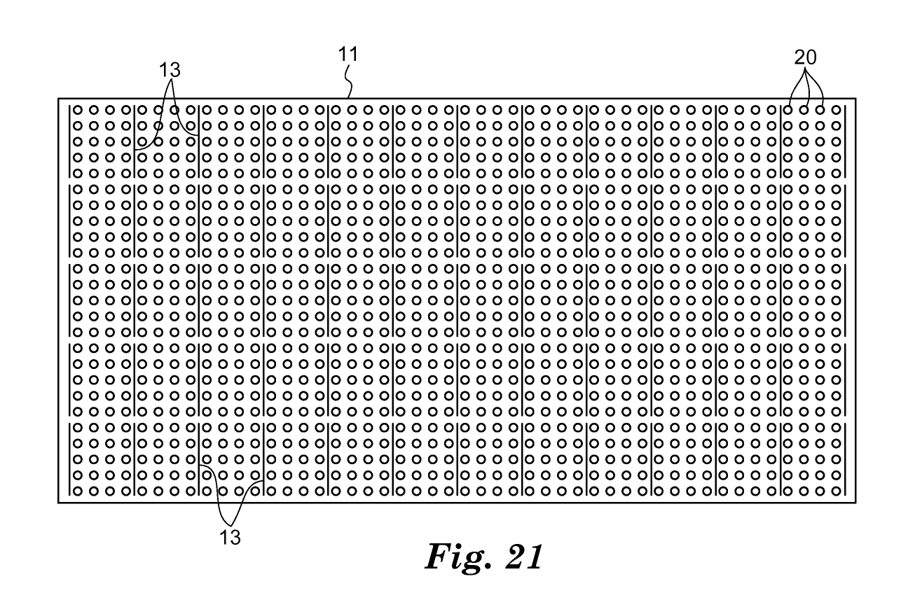

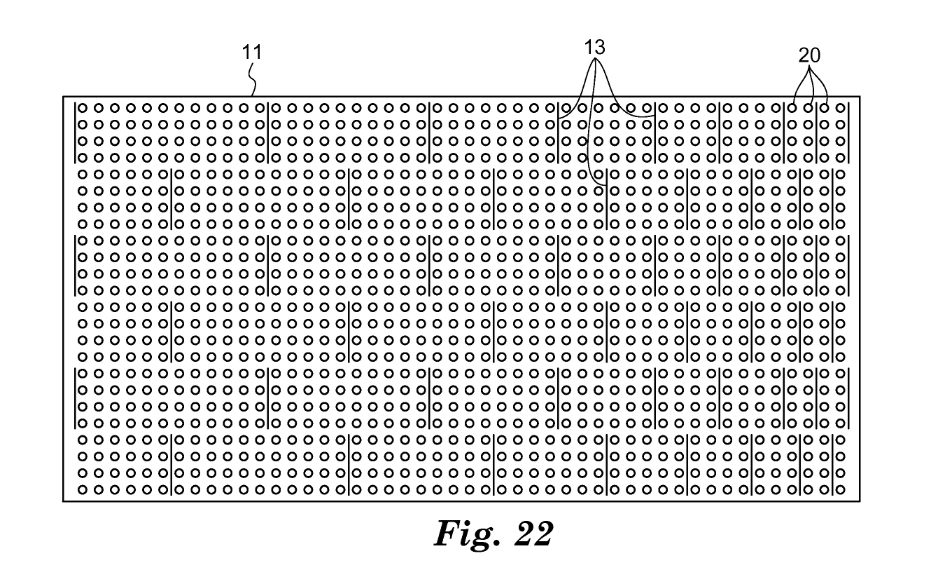

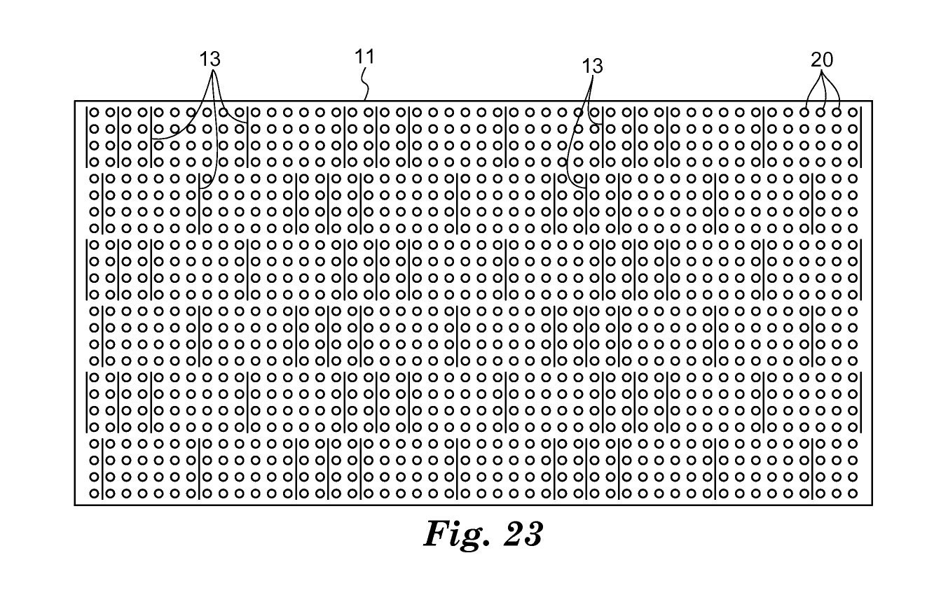

Slits may be arranged in any layout. For example, as shown in FIG. 19, slits 13 that extend continuously from near one end of the base 11 to near the opposite end may be arrayed at predetermined intervals. Alternatively, slits 13 may be arranged in a staggered pattern as shown in FIG. 20, or in a grid-like pattern as shown in FIG. 21. The density of the slits 13 need not be uniform across the entirety of the base 11; for example, as shown in FIGS. 22 and 23, sections including scattered slits 13 and sections including densely arrayed slits 13 may be present on a single base 11. In the example shown in FIG. 22, the slits 13 become progressively denser from one end of the base 11 toward the opposite end (in the drawing, from the left end toward the right end). In the example shown in FIG. 23, sections including densely arrayed slits 13 and sections including scattered slits 13 are disposed in alternation.

There is no limitation upon the length of the individual slits 13. All of the slits 13 on a single base 11 may have the same length, or a mixture of slits 13 of different lengths may be present. There is no limitation upon the spacing between two adjacent slits 13 in the direction in which the slits 13 extend, nor in the direction orthogonal to the direction in which the slits 13 extend. The spacing may be uniform or non-uniform on a single base 11. FIGS. 22 and 23 may be considered to illustrate embodiments in which the spacing between slits 13 in the direction orthogonal to the direction in which the slits 13 extend is not uniform.

In the examples described above, the slits extend in parallel with edges of the base 11, but there is likewise no limitation upon the direction in which the slits 13 extend. For example, the slits 13 may be slanted at a desired angle θ (such that 0°<θ<90°) with respect to the edges of the base 11.

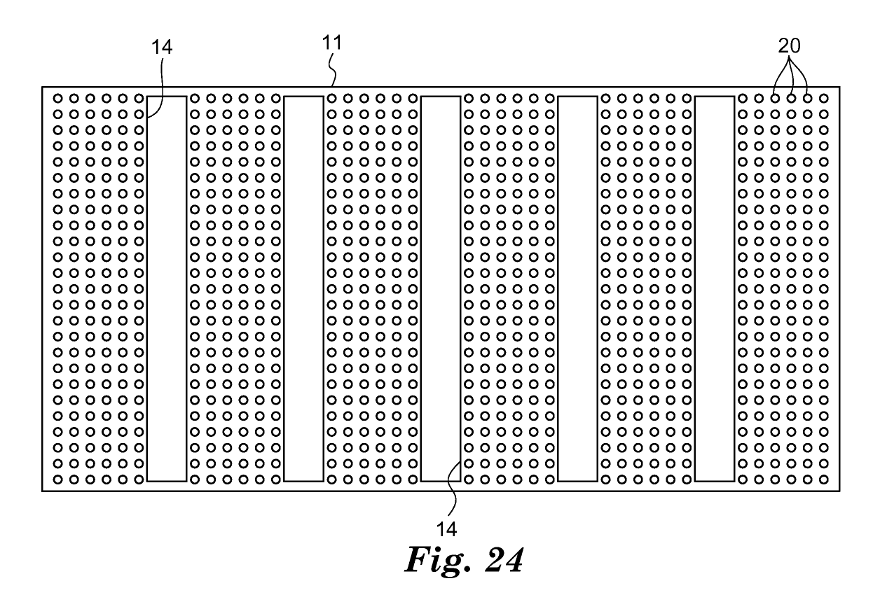

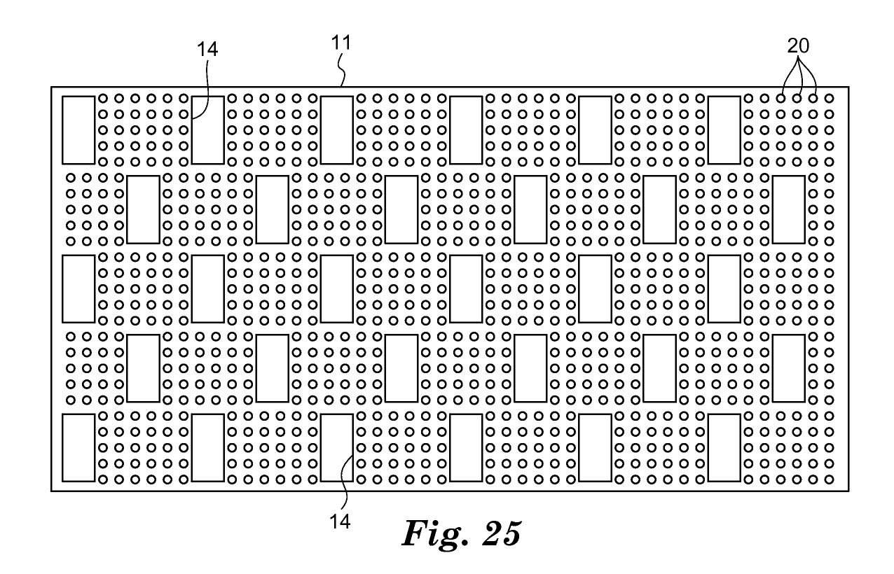

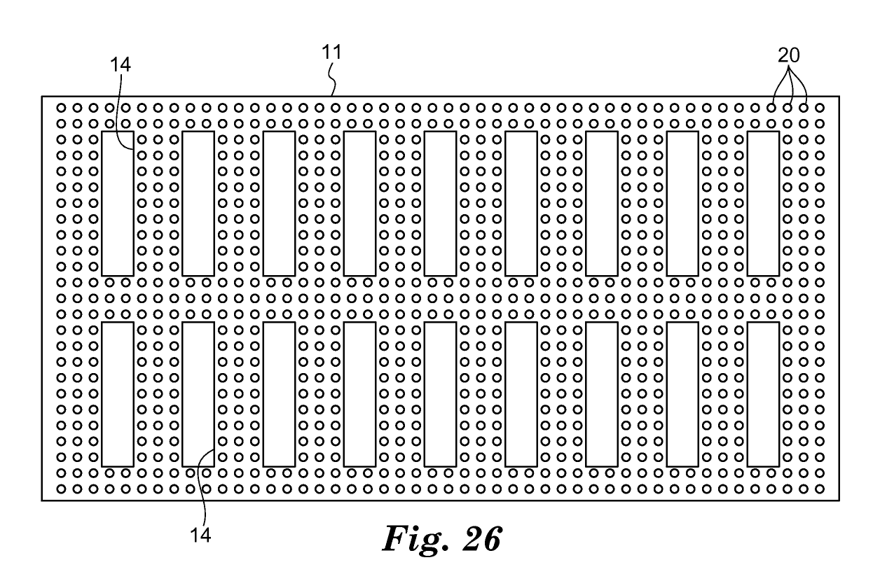

Openings may also be arranged in any layout. For example, as shown in FIG. 24, openings 14 that extend continuously from near one end of the base 11 to near the opposite end may be arrayed at predetermined intervals. Alternatively, the openings 14 may be arranged in a staggered pattern as shown in FIG. 25, or in a grid-like pattern as shown in FIG. 26. Although not shown in the drawings, an arrangement in which a mixture of sections of scattered openings and sections of densely arrayed openings are present on a single base 11 is also acceptable. There is likewise no limitation upon the spacing between two adjacent openings 14, and this spacing may be uniform or non-uniform. The openings 14 may be formed at a slant with respect to the edges of the base 11. In this way, various modifications of the layout of the openings are possible, as in the case of slits.

In the examples shown in FIGS. 24 through 26, the openings 14 are rectangular, but the opening is not limited to such a shape. For example, the opening may be rhomboidal, circular, elliptical, rectangular, star-shaped, wavy, or otherwise polygonal in shape. A mixture of openings 14 of various shapes may be present on a single base 11.

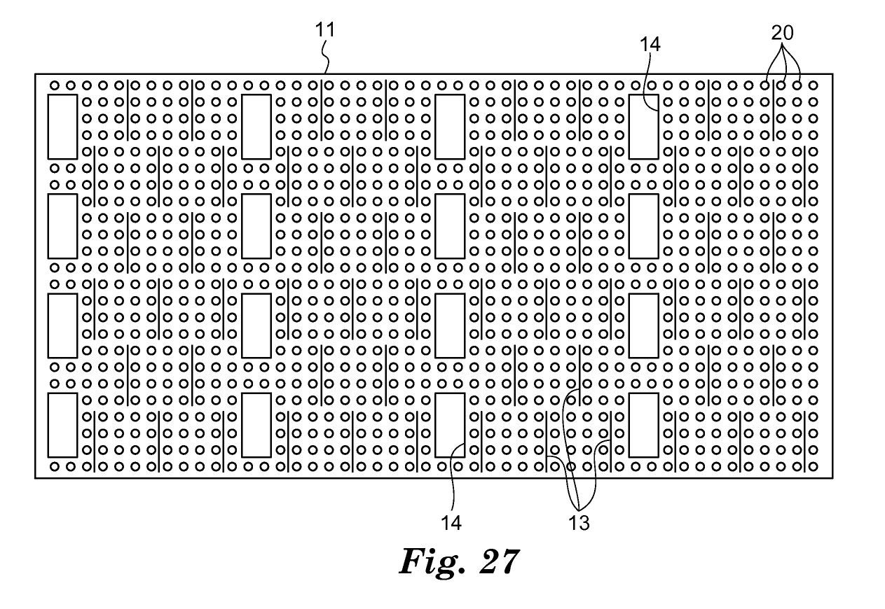

As shown in FIG. 27, a mixture of slits 13 and openings 14 may be present. Naturally, the arrangement of the various slits 13 and openings 14 is not limited to that shown in FIG. 27; any arrangement is acceptable.

The electrostatic filter according to the present embodiment includes multiple layers. Multiple layers, i.e., a laminated structure, can be formed by layering multiple layers. Specifically, such a structure can be formed by folding or wrapping a single sheet 10, or by stacking multiple sheets 10. Different types of sheets 10 can be joined together and wrapped to form multiple layers, or sheets including multiple layers can be wrapped together or stacked to form multiple layers. An adhesive layer or bonding layer may be formed on the upper surfaces of the protuberances 20 (i.e., the upper surface of the stem 21 or the caps 22), thereby preventing shifting during layering.

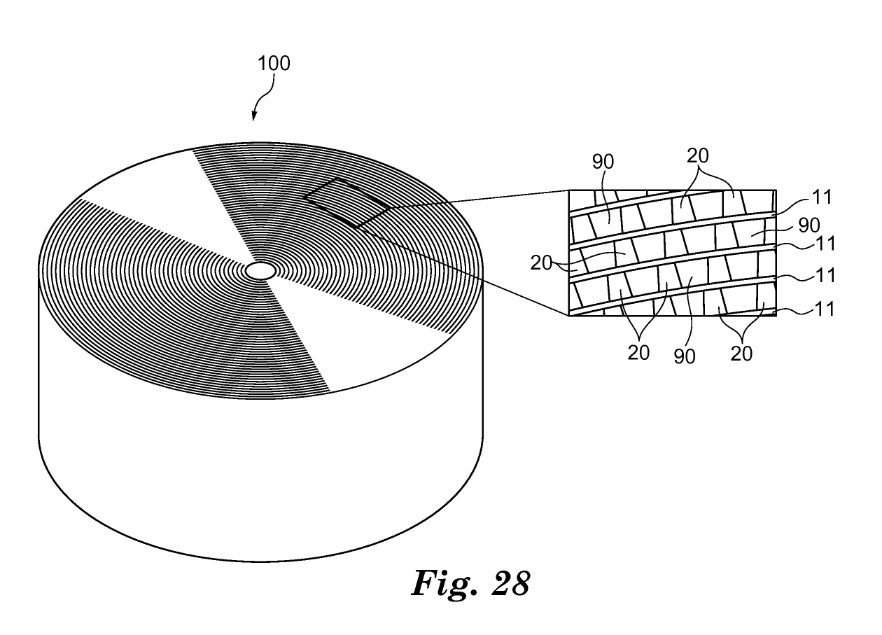

FIG. 28 depicts an electrostatic filter 100 obtained by wrapping a single strip-shaped sheet 10 into multiple layers. When manufacturing the electrostatic filter 100, the sheet 10 may be wrapped around a cylindrical member serving as a core for the electrostatic filter, or the sheet 10 can be wrapped without using a cylindrical member of this sort. If slits or openings are formed in the base 11, the rigidity of the sheet 10 itself will be reduced and the sheet 10 will become softer and more deformable, facilitating the work of tightly wrapping the sheet 10 and allowing for the manufacture of an electrostatic filter 100 in which adjacent pairs of layers are fitted more securely together. The dimensions or shapes of the slits or openings formed in the sheet 10 can be adjusted in order to modify the pliability of the sheet 10 as appropriate according to the attributes of the electrostatic filter (such as the method by which the filter is manufactured, the situation in which it is to be used, etc.). If a sheet 10 in which openings are formed is used, the lack of protuberances in the regions where the openings are present allows gas to flow unimpeded, thereby allowing the overall pressure loss of the electrostatic filter to be further reduced.

A shrink film may be used in isolation to hold together the electrostatic filter 100 shown in FIG. 28 without the use of adhesive or glue. Specifically, the outer circumference of the electrostatic filter 100 is wrapped in a contractible film, thereby holding the electrostatic filter 100 together. If, for example, a thermal shrink tube is used as the shrink film, the thermal shrink film is fitted over the outer circumference of the electrostatic filter 100, and then heated to cause the tube to shrink and compress the electrostatic filter 100 inward from the outside. Examples of the material used for the thermal shrink tube include polyethylene terephthalate (PET) and biaxially oriented polystyrene (BOPS). Alternatively, the shrink film can be wrapped around the electrostatic filter 100 under tension to compress the electrostatic filter 100 inward from the outside.

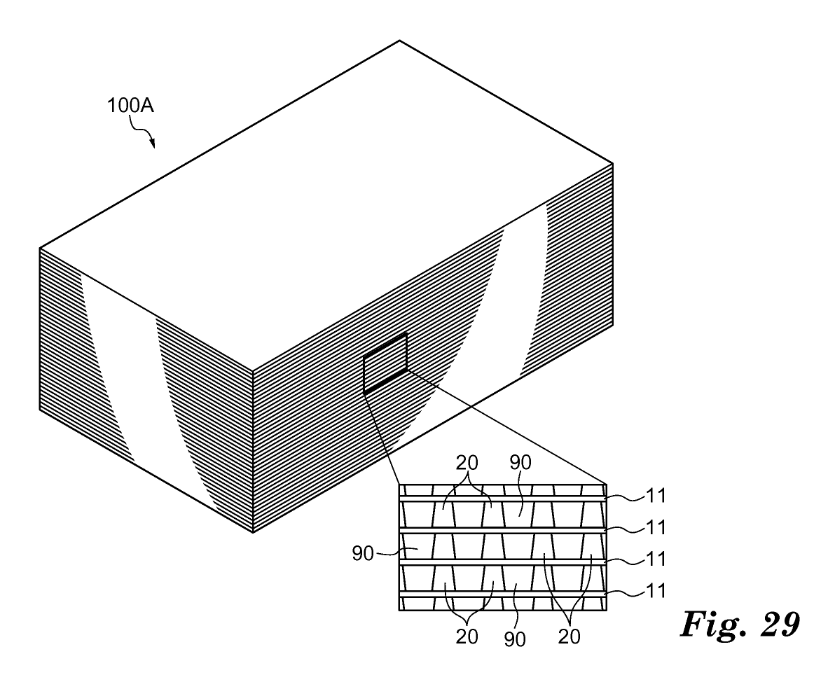

FIG. 29 depicts an electrostatic filter 100A obtained by layering multiple sheets 10. In this instance, multiple identically shaped sheets 10 may be layered to form the electrostatic filter 100A, or multiple sheets 10 may be layered, followed by trimming the side surfaces of the electrostatic filter to complete the electrostatic filter 100A. The electrostatic filter 100A shown in FIG. 29 is cuboid in shape, but the electrostatic filter 100A is not limited to such a shape, and may instead be cylindrical, ellipsoid, a desired polygonal shape, or a more complex shape.

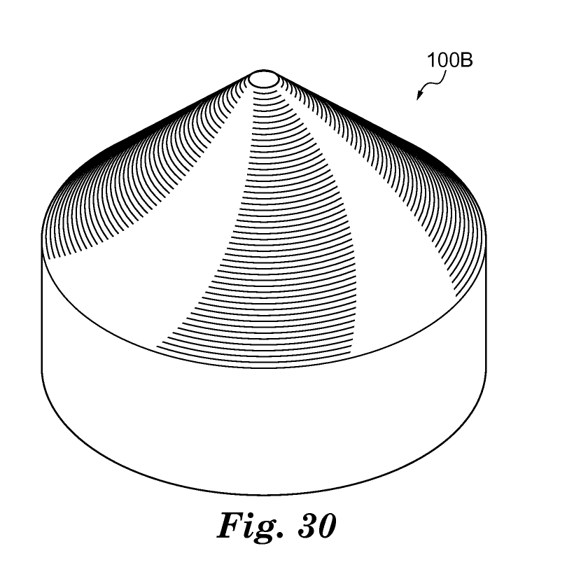

FIG. 30 depicts an electrostatic filter 100B imparted with a conical shape by wrapping a single strip-shaped sheet 10 into multiple layers, followed by pulling the center (i.e., the section corresponding to the core) outward.

In this way, electrostatic filters of various shapes can be manufactured from one or multiple sheets 10. In any case, the electrostatic filter according to the present embodiment includes numerous flow paths through which gases can flow (see the flow paths 90 in the magnified sections in FIGS. 28 and 29). The minimum thickness of the electrostatic filter as a whole (i.e., the length of the flow paths of the filter) may be 1 mm, 3 mm, 5 mm, 10 mm, or 15 mm, and the maximum thickness may be 700 mm, 600 mm, 500 mm, 250 mm, or 100 mm. The minimum diameter of the electrostatic filter may be 10 mm, 15 mm, 20 mm, 25 mm, or 30 mm, and the maximum diameter may be 1000 mm, 900 mm, 800 mm, 700 mm, or 600 mm.

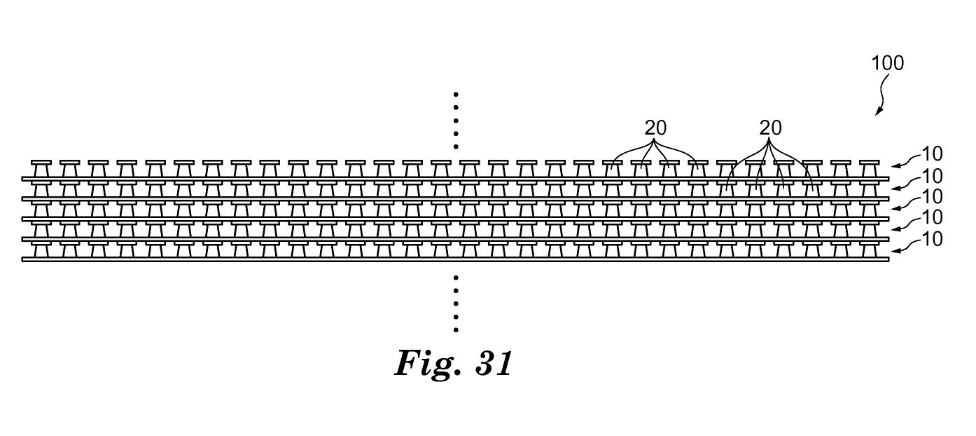

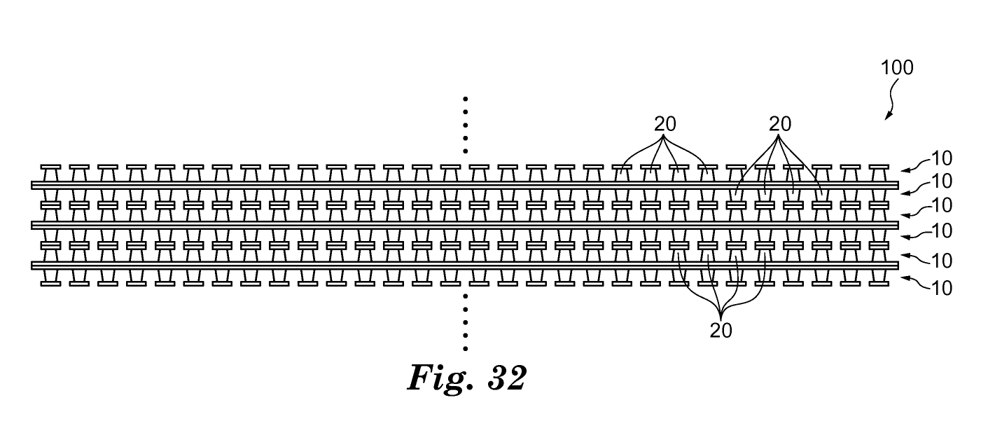

There is no limitation upon the manner in which the sheet 10 is layered. For example, as shown in FIG. 31, sheets may be layered so that the apexes (highest points) of the protuberances 20 of one layer contact the rear surface of the adjacent layer. Alternatively, as shown in FIG. 32, a process of layering a first layer and a second layer so that the protuberances 20 of the first layer and the protuberances 20 of the second layer adjacent to the first layer face each other, followed by layering the first layer and a third layer so that the rear surface of the first layer and the rear surface of the third layer adjacent to the first layer contact each other, may be repeated. In this case, an electrostatic filter is obtained in which multiple sheets 10 are layered in the order of base, protuberances, protuberances, base, base, protuberances, protuberances, base, and so on. An electrostatic filter having the form shown in FIG. 32 can be formed, for example, by folding a single sheet 10 back and forth over itself. In the example shown in FIG. 32, the angle θ is the angle formed by the root-ward side surfaces of the protuberances 20 of the first layer and the base of the first layer. The angle φ is the angle formed by the tip side surfaces of the protuberances 20 of the first layer and the base of the second layer; more specifically, it is the angle formed by an imaginary line extending from the tip side surfaces of the protuberances 20 of the first layer and the base of the second layer.

When viewing the electrostatic filter from the inlet or outlet thereof, the protuberances 20 may be aligned in rows along the layering direction, disposed in a staggered arrangement, or randomly disposed.

In the examples shown in FIGS. 28 to 32, all of the layers are of the same type, but the electrostatic filter may also include multiple different types of layers. For example, the electrostatic filter may include a layer (additional functional layer) other than the layers formed from sheets 10 (basic layers). For example, the additional functional layer may be activated charcoal used to remove organic components or odors, an absorber such as zeolite or aluminosilicate, or a deodorizing catalyst such as copper-ascorbic acid. Alternatively, the additional functional layer may be a desiccant such as silica gel, zeolite, calcium chloride, or activated alumina, a UV microbicidal or other type of disinfectant, or a fragrance such as gloxal, a methacrylic acid ester, or a perfume. Alternatively, the additional functional layer may be an ozone removing agent containing a metal such as an oxide supported upon a carrier such as Mg, Ag, Fe, Co, Ni, Pt, Pd, or Rn, or alumina, silica alumina, zirconia, diatomaceous earth, silica zirconium, or titania. A single electrostatic filter may include multiple types of additional functional layers.

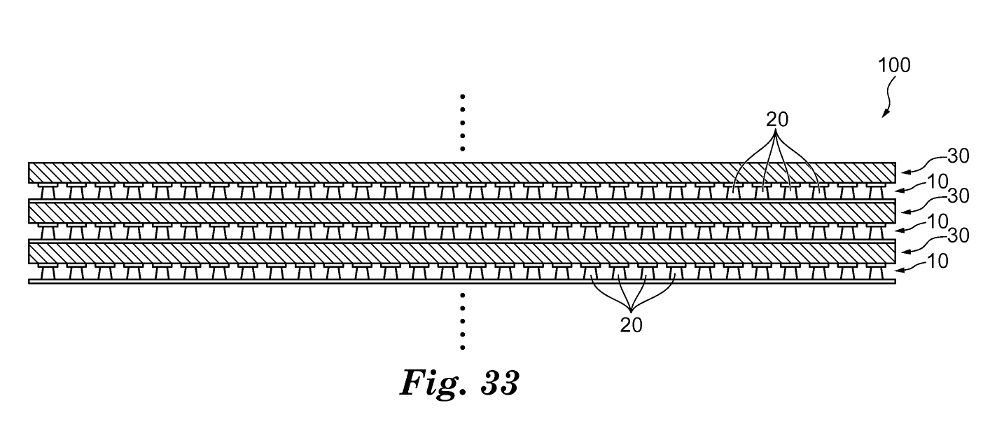

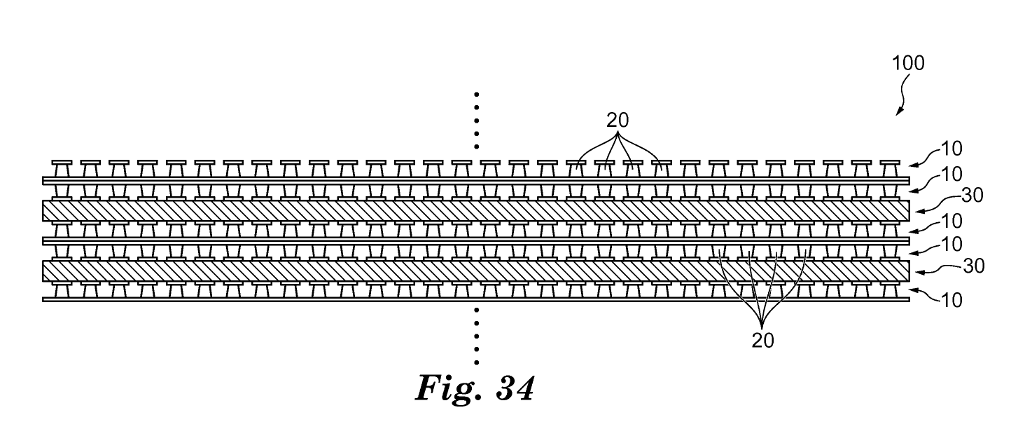

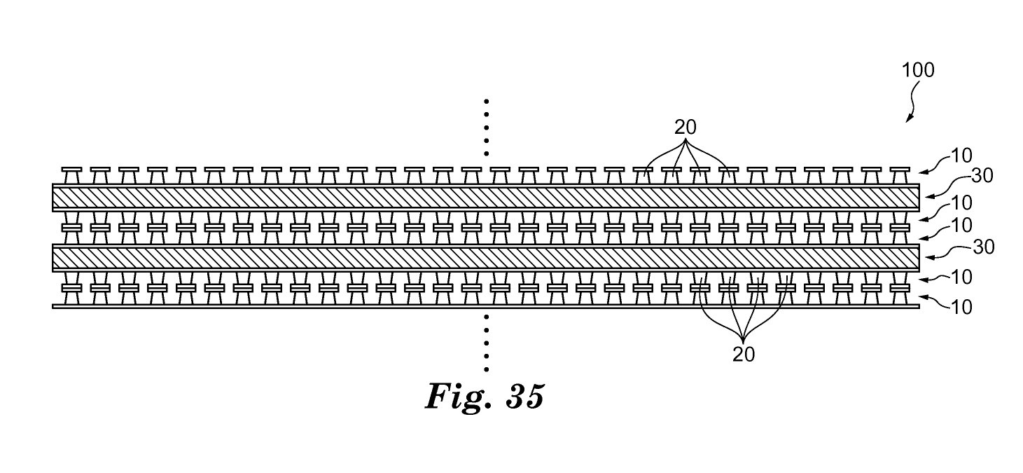

As shown in FIG. 33, an additional functional layer 30 may be inserted between the protuberances 20 of a basic layer (sheet) 10 and the rear surface of the adjacent basic layer (sheet) 10. In this case, the basic layer (sheet) 10 is equivalent to a first layer, and the additional functional layer 30 is equivalent to a second layer provided with the base. Alternatively, as shown in FIG. 34, the additional functional layer 30 may be inserted between the protuberances 20 of the basic layer 10 and the protuberances 20 of the adjacent basic layer 10. In this case as well, the basic layer (sheet) 10 is equivalent to the first layer, and the additional functional layer 30 is equivalent to the second layer provided with the base. Alternatively, as shown in FIG. 35, the additional functional layer 30 may be inserted between the rear surface of one basic layer 10 and the rear surface of the adjacent basic layer 10. In this case, the angles θ, φ are defined as in the example of FIG. 32. A desired ratio of basic layers to additional functional layers in the stack may be selected. For example, basic layers 10 and additional functional layers 30 may be alternately disposed to yield a ratio of 1:1. A process of stacking two basic layers 10 followed by stacking one additional functional layer 30 thereupon can be repeated to yield a ratio of 2:1. The ratio may be 3:1, 1:2, or a different value.

Alternatively, the electrostatic filter may include multiple types of layers having firm protuberances of different shapes. Specifically, in this case, a first layer and a second layer are different types of layers, and may have different sheet materials or protuberance shapes, dimensions, densities, etc.

### EXAMPLES

The present invention will now be described in greater detail on the basis of working examples, but the present invention is not limited thereto.

### Working Example 1

Polypropylene was used as a material to form a sheet for forming an electrostatic filter. In this example, the protuberances include stems but lack caps, and thus are shaped as shown in FIG. 2(a). The projected image obtained by projecting the stems against an imaginary plane corresponded to that of pattern 3 or 5 described above. The thickness of the base was roughly 0.1 to 0.2 mm, the height of the protuberances was roughly 0.3 to 0.4 mm, and the maximum width of the tips of the protuberances was roughly 0.1 to 0.2 mm. The protuberances were formed on the base so as to be arranged in a grid-like pattern at a spacing of roughly 0.8 mm. The sheet was electret treated using a Wedge Inc. apparatus having a machine width of 1,200 mm. During the electret treatment, heating (100° C.) was performed for five seconds, cooling was performed for five seconds, and a voltage of 13.5 KV was applied. The electret-treated sheet was wrapped into a roll (diameter: approx. 300 mm). Next, the film was unrolled and cut into 50 mm×3 mm, 50 mm×5 mm, 50 mm×10 mm, and 50 mm×15 mm sheets. Multiple layers of cut film were then stacked in the direction in which the protuberances projected and assembled into a block shape having a longitudinal dimension of 50 mm (FIG. 29) to manufacture an electrostatic filter. The dimensions (longitudinal×lateral×width) of the four different types of filters were 50 mm×50 mm×3 mm, 50 mm×50 mm×5 mm, 50 mm×50 mm×10 mm, and 50 mm×50 mm×15 mm. In this context, the “width” of the filter can be considered the thickness or flow path length of the filter.

The performance of the four electrostatic filters of different widths was evaluated using a TSI MODEL 8130 inspection apparatus. Sodium chloride particles having dimensions of approx. 0.10 μm in terms of count median diameter were used as inspection particles at a density of approximately 50 mg/m³ (within a variable range of 15%) within the gas stream. The time necessary to completely introduce 100 mg of sodium chloride into the gas stream was taken as the inspection time.

Trapping efficiency E (%) was calculated according to the following formula, in which Ca is the particle concentration (mg/m³) of the gas stream before passing through the filter, and Cb is the particle concentration (mg/m³) of the gas stream after passing through the filter.

E=(Ca−Cb)/Ca×100

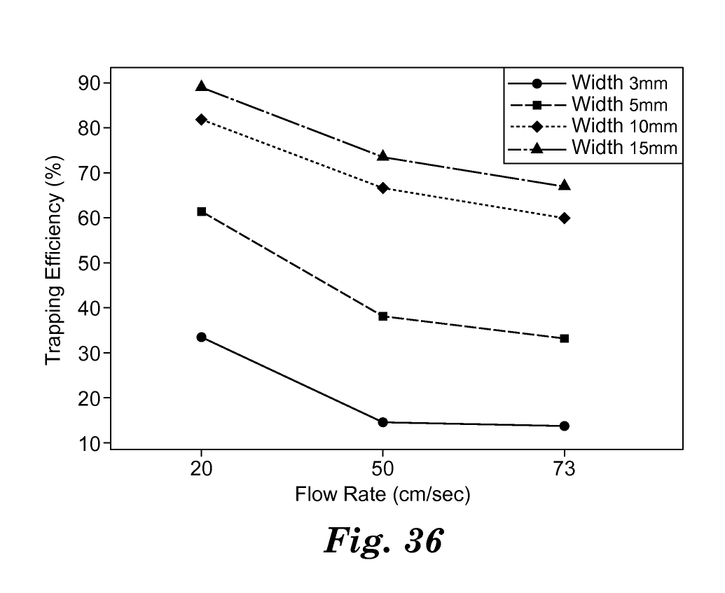

FIG. 36 is a graph showing trapping efficiency for the four different types of electrostatic filters. The horizontal axis is the flow rate (cm/sec), and the vertical axis is the trapping efficiency (%). Three different stages were set for flow rate as shown in the graph, and the trapping efficiency of the four different electrostatic filters was measured at each of the flow rates.

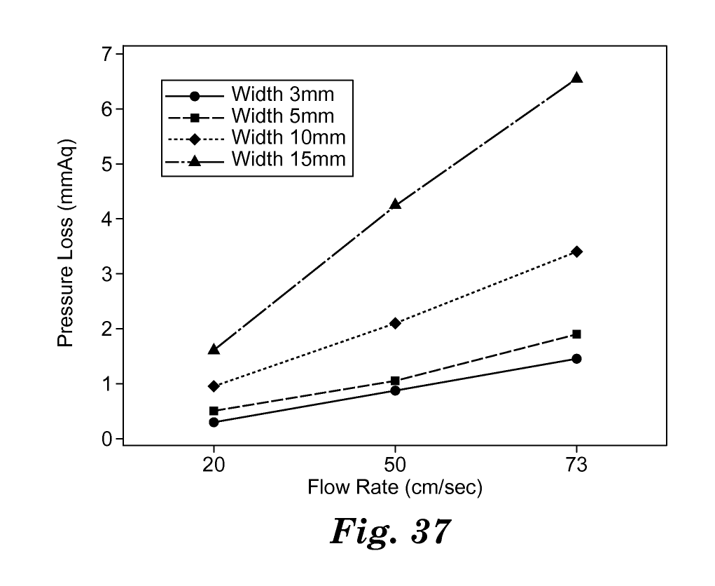

FIG. 37 is a graph showing pressure loss for the four different types of electrostatic filters. The horizontal axis is the flow rate (cm/sec), and the vertical axis is the pressure loss (mmAq). 1 mmAq=9.80665 Pa. Flow rate settings are as shown in FIG. 36.

The results from working example 1 indicate that the width of the electrostatic filter can be controlled in order to adjust the trapping efficiency and pressure loss of the electrostatic filter, allowing for the design of an article that is suitable for the application.

### Working Example 2

An electrostatic filter identical to that manufactured in working example 1 and produced using a 5 mm-wide sheet was prepared as a working example. The following commercially available electrostatic filters having the same dimensions as the electrostatic filter of the working example were used as reference examples.

### Reference Example 1

### Nonwoven Fabric High-electrostatic Air Filter (Pleated; Pleat Width: 5 mm) (High-End Article)

### Reference Example 2

### Honeycombed Polyolefin Electrostatic Air Filter.

### Reference Example 3

### Nonwoven Fabric Low-Electrostatic Air Filter (Pleated; Pleat Width: 5 mm) (General-Purpose Article)

### Reference Example 4

### Nonwoven Fabric Low-Electrostatic Air Filter (Pleated; Pleat Width: 2 mm) (General-Purpose Article)

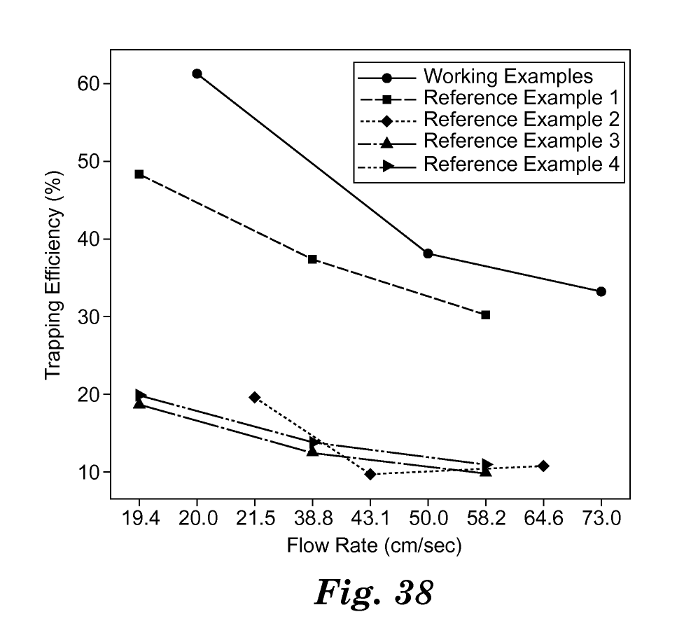

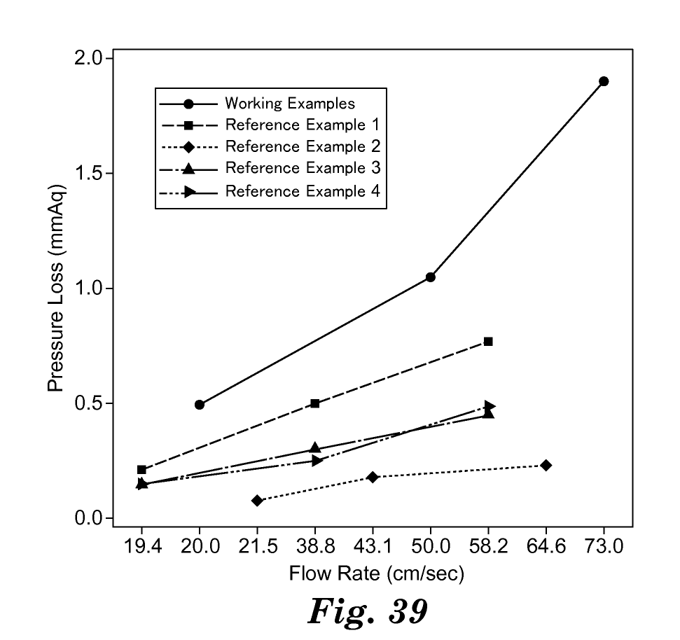

The trapping efficiency and pressure loss of the electrostatic filters according to the working example and the reference examples were measured according to the same methods as in working example 1. FIG. 38 is a graph showing the trapping efficiency of the working example and the four reference examples, in which the horizontal and vertical axes represent flow rate (cm/sec) and trapping efficiency (%), respectively. FIG. 39 is a graph showing the pressure loss of the working example and the four reference examples, in which the horizontal and vertical axes represent flow rate (cm/sec) and pressure loss (mmAq), respectively. In working example 2, three standards were used for flow rate, which was calculated according to the dimensions of the samples used in the measurements.

The results of working example 2 show that the electrostatic filter according to the working example exhibited performance (in terms of trapping efficiency and pressure loss) comparable to that of the nonwoven fabric high-electrostatic air filter constituting the high-end product (reference example 1).

As discussed above, an electrostatic filter according to one aspect of the present invention is an electrostatic filter including a first layer and a second layer, the first layer being provided with a base and a plurality of firm protuberances extending from a face of the base and adjacent to the second layer. The protuberances include a stem having a root-ward side surface and a tip side surface, the second layer being provided with a base, a first angle constituted by either the angle between the root-ward side surface of the stem and the base of the first layer or the angle between the tip side surface of the stem and the base of the second layer being at least 90° and less than 180°, and a second angle constituted by the other of the two angles thereof being at least 45° and less than 180°.

An article according to one aspect of the present invention is provided with the electrostatic filter described above.

In this aspect, the protuberances are firm, thereby stabilizing the layered structure of the filter and ensuring a flow path between the layers. In addition, broad corners for the gas flow path are established at the root and tip sides of the stems of the protuberances, with the result that gas flows not only near the center of the flow path formed between two adjacent protuberances, but also near the corners thereof, facilitating the flow of gas through the filter. It is thereby possible to minimize pressure loss and improve trapping efficiency while stabilizing the layered structure of the filter.

An electrostatic filter according to one aspect of the present invention has a structure that allows the width (thickness or flow path length) of the filter to be increased and is resistant to clogging even if the width (thickness or flow path length) of the filter is increased, allowing the lifespan of the product to be extended compared to electrostatic filters made using nonwoven fabric.

In an electrostatic filter according to another aspect, the first layer and the second layer may be the same type of layer.

In an electrostatic filter according to another aspect, the first layer and the second layer may be different types of layers.

In an electrostatic filter according to another aspect, the second layer may be a different type of layer from the first layer, and may be further provided with a plurality of firm projections that extend from a front surface of the base of the second layer.

In an electrostatic filter according to another embodiment, the second angle may be at least 90° and less than 180°.

In this case, corners of at least 90° are established at the root and tip sides of the stems of the protuberances, with the result that gas flows more readily near the corners of the flow path as well, thereby facilitating the flow of gas through the electrostatic filter.

In an electrostatic filter according to another aspect, two outer edges of a projected image obtained by projecting the stem onto an imaginary plane orthogonal to the base of the first layer need not be convex with respect to the exterior of the projected image along the entire lengths thereof.

As a result, the protuberances are formed so that the side surfaces thereof are not convex with respect to the exterior along the entire lengths thereof, thereby increasing the diameter of the flow path and facilitating the flow of gas through the electrostatic filter.

In an electrostatic filter according to another aspect, at least one of the two outer edges may be convex with respect to the interior of the projected image along its entire length.

As a result, the protuberances are formed so that the side surfaces thereof are convex with respect to the interior along the entire lengths thereof, thereby further increasing the diameter of the flow path and facilitating the flow of gas through the electrostatic filter.

In an electrostatic filter according to another aspect, a slit-shaped groove, slit-shaped through-hole, or opening may be formed on the base of the first layer.

In this case, the sheet is more pliable, thereby allowing the sheet to be wrapped up into a smaller roll when manufacturing the electrostatic filter. This allows for the manufacture of an electrostatic filter, the layers of which are closely layered over each other. In addition, the diversity of options for the flow path of the filter is increased, allowing for the design of an article that is suited for the application.

The foregoing has been a detailed description of the present invention with respect to embodiments thereof. However, the present invention is not limited to the embodiments described above. Various modifications may be made to the present invention to the extent that they do not depart from the gist of the present invention.

What is claimed is:

1. An electrostatic filter comprising:
a first layer and a second layer;
the first layer being provided with a base and a plurality of firm protuberances extending from a face of the base and adjacent to the second layer, the protuberances comprising a stem having a root-ward side surface and a tip side surface;
the second layer being provided with a base; and
a first angle constituted by either an angle between the root-ward side surface of the stem and the base of the first layer or an angle between the tip side surface of the stem and the base of the second layer being at least 90° and less than 180°, and a second angle constituted by the other of the two angles thereof being at least 45° and less than 180°.

2. The electrostatic filter according to claim 1, wherein the first layer and the second layer are the same type of layer.

3. The electrostatic filter according to claim 1, wherein the first layer and the second layer are different types of layers.

4. The electrostatic filter according to claim 3, wherein the second layer further comprises a plurality of firm projections that extend from a front surface of the base of the second layer.

5. The electrostatic filter according to claim 1, wherein the second angle is at least 90° and less than 180°.

6. The electrostatic filter according to claim 1, wherein two outer edges of a projected image obtained by projecting the stem onto an imaginary plane orthogonal to the base of the first layer are not convex with respect to an exterior of the projected image along entire lengths thereof

7. The electrostatic filter according to claim 6, wherein at least one of the two outer edges is convex with respect to an interior of the projected image along the entire length thereof

8. The electrostatic filter according to claim 1, wherein a slit-shaped groove, a slit-shaped through-hole, or an opening is formed in the base of the first layer.

9. An article comprising the electrostatic filter according to claim 1.
